(19) United States
(12) Patent Application Publication
(10) Pub. No.: US 2026/0288816 A1
(43) Pub. Date: Sep. 24, 2026

(54) SYSTEM

(71) Applicant: SoftBank Group Corp., Tokyo (JP)

(72) Inventor: Satomi FUKUOKA, Tokyo (JP)

(73) Assignee: SoftBank Group Corp., Tokyo (JP)

(21) Appl. No.: 19/567,362

(22) Filed: Mar. 16, 2026

(30) Foreign Application Priority Data
Mar. 19, 2025 (JP) 2025-045047

(51) Int. Cl. G06F 16/3329; G06F 40/284; G06F 40/30; G06N 3/0499

(52) U.S. Cl. CPC G06F 16/33295; G06F 40/284; G06F 40/30; G06N 3/0499

(57) ABSTRACT

A system includes a processor that is configured to use a generative AI model to receive and analyze information from a user, input a prompt to the generative AI model to cause the generative AI model to generate concrete advice for supporting personal branding of the user, and use an emotion analysis algorithm to analyze an emotion of the user to recognize the emotion, and adjust the advice based on the emotion.

### CROSS-REFERENCE TO RELATED APPLICATION

This application is based on and claims priority under 35 USC 119 from Japanese Patent Application No. 2025-045047 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for supporting personal branding primarily rely on static questionnaires, template-based recommendations, or simple rule-based analytics that fail to capture the nuanced combination of a user's personal information, such as interests, skills, and experiences, together with the user's current emotional state. As a result, the advice provided to users is often generic, not context-aware, and not sufficiently tailored to how the user is feeling at the time of interaction. Furthermore, traditional systems do not effectively leverage recent advances in generative AI models and emotion analysis algorithms in an integrated manner, and therefore cannot dynamically adjust the content and tone of personal branding advice in real time. This leads to a technical problem in that it is difficult to automatically generate highly personalized, emotionally adaptive personal branding guidance that remains relevant as the user's profile and emotional state change.

### SUMMARY

In order to solve the above-described problem, a system is provided comprising a processor configured to use a generative AI model to receive and analyze information from a user and to input a prompt to the generative AI model so as to cause the generative AI model to generate concrete advice for supporting personal branding of the user. The processor is further configured to use an emotion analysis algorithm to analyze an emotion of the user to recognize the emotion and to adjust the advice based on the recognized emotion. In one aspect, the processor is configured to collect personal information, interests, skills, and experiences of the user and to input, to the generative AI model, a prompt for causing the generative AI model to provide personal branding advice based on the collected personal information, interests, skills, and experiences. In another aspect, the processor is configured to analyze message content of the user and an expressed emotion of the user, to identify an emotional state of the user by using the emotion analysis algorithm, to generate a prompt for causing generation of content based on the identified emotional state of the user, and to provide the generated content to the user. By integrating generative AI based content generation with emotion-aware analysis in this manner, the system can automatically generate and adapt personal branding advice that is both profile-specific and responsive to the user's current emotional state.

The term “system” refers to an arrangement of one or more hardware and software components that cooperate to execute processing related to receiving user information, performing analysis, and generating advice, and may include servers, client devices, storage, and networks.

The term “processor” refers to one or more hardware processing units, such as a central processing unit (CPU), a graphics processing unit (GPU), or a dedicated accelerator, that execute instructions to perform the operations described in the claims, including analyzing user information, generating prompts, invoking generative AI models, and performing emotion analysis.

The term “generative AI model” refers to a machine learning model, such as a neural network trained on large datasets, that is capable of generating text or other content in response to input data or prompts, and that is used to produce personal branding advice or other content for the user.

The term “prompt” refers to text, parameters, or structured input data that is supplied to the generative AI model in order to instruct the generative AI model to perform a specific generation task, such as generating concrete advice for supporting personal branding of the user or generating content based on an emotional state of the user.

The term “user” refers to a human individual who interacts with the system, provides information such as personal information, interests, skills, experiences, and messages, and receives advice or content generated by the system.

The term “personal branding” refers to a manner in which the user defines, presents, and communicates their strengths, qualifications, values, and professional or personal identity to others, including how the user describes themselves in messages and other communications.

The term “information from a user” refers to data provided directly or indirectly by the user, including but not limited to personal information, interests, skills, experiences, message content, and any other input that reflects the user's background, preferences, or current context.

The term “personal information” refers to information that identifies or characterizes the user, such as name, occupation, background, education, career history, or other profile-related data.

The term “interests” refers to topics, fields, activities, or domains that the user indicates as areas of curiosity, engagement, or ongoing attention, such as technology, design, finance, or hobbies.

The term “skills” refers to capabilities, competencies, or proficiencies that the user possesses, including technical skills, soft skills, and domain-specific abilities that can be used or highlighted in personal branding.

The term “experiences” refers to past activities, roles, projects, jobs, or events in which the user has participated, and which contribute to the user's background and can be referenced in personal branding advice.

The term “emotion analysis algorithm” refers to a software component or set of instructions executable by the processor, which is designed to process input data such as text, voice, or other signals from the user, and to infer or classify an emotion or emotional state of the user, such as happiness, sadness, anxiety, or confidence.

The term “emotion” refers to a mental or affective state of the user, such as positive, neutral, or negative feelings, which can be inferred from user inputs including message content, tone, or other behavioral signals.

The term “emotional state” refers to a condition representing a type or intensity of the user's emotion at a particular time, identified by the emotion analysis algorithm, and used to adapt or customize the advice or content generated by the system.

The term “message content” refers to text, symbols, or other communicative data created or sent by the user through a messaging interface or similar communication channel, which can be analyzed to determine topics, tone, and expressed emotion.

The term “concrete advice” refers to specific, actionable guidance provided to the user, including explicit suggestions on how to describe themselves, what aspects of their skills or experiences to emphasize, and how to adjust wording or tone to support their personal branding.

The term “content” refers to information generated by the generative AI model, including but not limited to text, messages, recommendations, or explanations, that is presented to the user for purposes such as personal branding support or emotional adaptation of communications.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

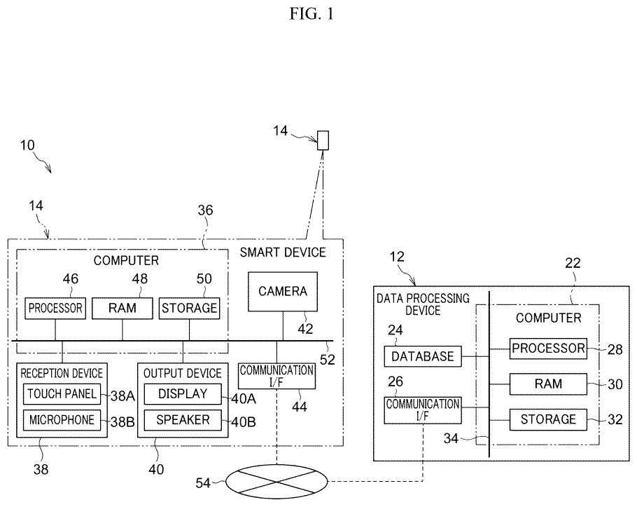

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

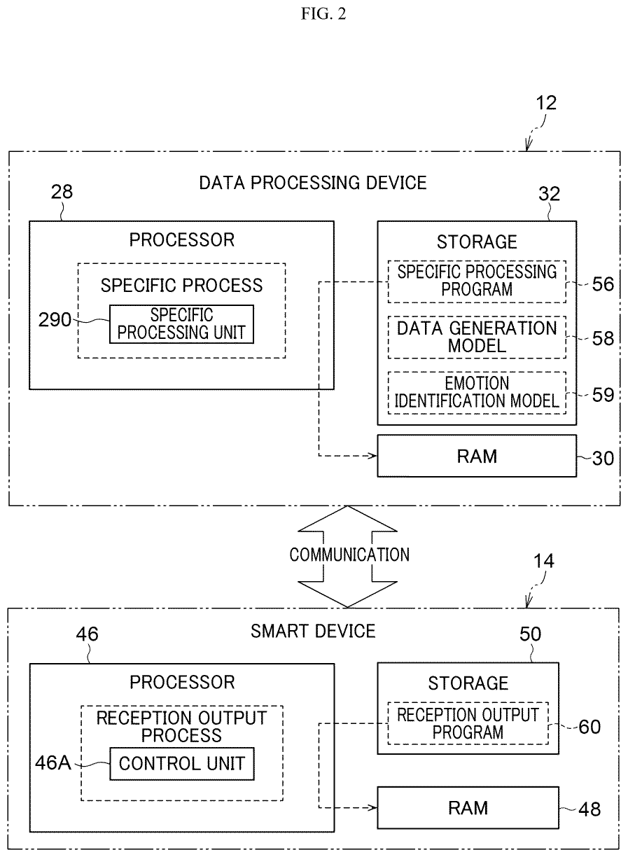

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented personal branding support systems typically rely on static rule sets, simple keyword matching, or template-based content generation. Such systems often treat user input as flat text, without robustly structuring the information into machine-usable representations that capture user interests, abilities, experiences, and emotional states. As a result, the generated advice is frequently generic, repetitive, and insensitive to subtle differences in user profiles.

Further, existing conversational interfaces generally submit raw user messages directly to a generative model or simple heuristic engine, without a dedicated pipeline that: (i) normalizes and structures user data; (ii) decomposes the data into feature categories such as strengths, goals, and behavior history; and (iii) constructs a context-aware prompt sentence that explicitly encodes this structure for downstream generation. This lack of an intermediate representation leads to inefficient use of computational resources and limits the controllability and consistency of model outputs.

In addition, known systems that utilize sentiment detection or emotion recognition commonly use such signals only for superficial tone adjustment (for example, choosing “positive” or “neutral” wording), and do not integrally combine emotion analysis with structured user profiling and iterative prompt construction. Consequently, the systems cannot reliably adapt to the evolving emotional state and updated goals of the user over multiple interaction turns, nor can they maintain coherent, progressively refined advice across a session.

From a computer-technology perspective, there is a need for a server-side architecture that improves the way user-generated natural language input is transformed into structured, semantically rich representations, and how such representations are used to build prompt sentences for a generative AI model. There is also a need for an iterative control mechanism that manages the feedback loop between user input, analysis modules, prompt construction, and generative inference, such that the overall system behavior becomes more stable, predictable, and resource-efficient.

Accordingly, the technical problem to be solved is to improve computer-based processing for personal branding support by providing: (i) a structured information pipeline that integrates natural language processing and emotion analysis; (ii) a prompt generation mechanism that dynamically encodes user characteristics, goals, and emotional states; and (iii) an iterative control mechanism that updates both prompts and generated advice in response to additional user input, thereby achieving more accurate, contextually coherent, and computationally efficient advice generation in a conversational environment.

The specific processing by the specific processing unit 290 of the data processing device 12 in Example 1 is realized by the following means.

The present invention provides a server comprising a processor configured to receive, via a communication terminal, information regarding interests, abilities, experiences, and emotions of a user and convert the information into structured information; analyze text data included in the structured information using a natural language processing algorithm and an emotion analysis algorithm to extract user characteristics, user goals, and an emotional state; dynamically construct a prompt sentence that encodes the extracted user characteristics, user goals, and emotional state and is configured to instruct a generative AI model to generate support content related to personal self-expression; input the constructed prompt sentence into the generative AI model and cause the generative AI model to execute inference processing to generate advice content for self-brand formation in accordance with the user characteristics and the emotional state; convert the advice content into a data format and transmit the advice content to the communication terminal using a secure communication protocol such that the advice content is displayed on the communication terminal; and update the prompt sentence and the advice content in response to additional information or additional input from the user by re-analyzing the additional input, reconstructing the prompt sentence to reflect updated user goals or constraint conditions, and sequentially refining the advice content based on a dialogue history with the user. This enables an improvement in computer-implemented processing for personal branding support by providing a structured, algorithmically controlled pipeline that integrates natural language processing, emotion analysis, prompt sentence construction, and iterative generative inference, thereby allowing a computing system to generate context-aware, progressively refined advice with enhanced stability, controllability, and efficiency compared to conventional systems that process unstructured input directly.

The term “communication terminal” refers to an electronic device operated by a user, such as a mobile device, a tablet, a desktop device, or a similar computing device, that transmits user input to a server and receives advice content from the server via a communication network.

The term “structured information” refers to data that has been transformed from raw user input into a machine-processable format, such as a record, vector, or labeled data structure, in which elements including interests, abilities, experiences, and emotions are organized according to predefined fields or categories.

The term “information input unit” refers to a functional component implemented by hardware, software, or a combination thereof, configured to receive user-generated data via a communication terminal and convert the received data into structured information for subsequent processing.

The term “information analysis unit” refers to a functional component implemented by hardware, software, or a combination thereof, configured to analyze structured information using algorithms including natural language processing algorithms and emotion analysis algorithms to extract user characteristics, user goals, and an emotional state.

The term “natural language processing algorithm” refers to a computational procedure executed by a processor to analyze and process text data in human languages, including but not limited to tokenization, part-of-speech tagging, entity recognition, feature extraction, and semantic analysis.

The term “emotion analysis algorithm” refers to a computational procedure executed by a processor to detect, classify, or estimate an emotional state of a user from text data, structured information, or other signals, such as sentiment scores, emotion categories, or affective intensity values.

The term “user characteristics” refers to attributes derived from user input, including strengths, abilities, preferences, tendencies, and behavior patterns, that describe how the user typically acts or what the user is good at.

The term “user goals” refers to objectives or desired outcomes explicitly or implicitly indicated by the user in the input, including but not limited to aspirations regarding self-branding, communication style, leadership, or professional positioning.

The term “emotional state” refers to a representation of a user's affective condition at a given time, such as being positive, negative, neutral, confident, anxious, or other emotion-related states, as determined by an emotion analysis algorithm.

The term “prompt sentence” refers to a text sequence or data structure that encodes instructions, context, and user-related information, provided as input to a generative AI model to control or guide the generation of output content.

The term “prompt generation unit” refers to a functional component implemented by hardware, software, or a combination thereof, configured to dynamically construct a prompt sentence based on extracted user characteristics, user goals, and an emotional state, and to prepare such prompt sentence for input to a generative AI model.

The term “generative AI model” refers to a machine learning model, such as a neural network-based language model, configured to generate text or other content in response to input data including a prompt sentence, by performing inference based on parameters learned from training data.

The term “advice content” refers to information generated by a generative AI model, including recommendations, strategies, guidance, or instructions, that are tailored to support a user's self-brand formation or personal self-expression based on user-specific data.

The term “advice generation unit” refers to a functional component implemented by hardware, software, or a combination thereof, configured to provide a prompt sentence to a generative AI model, receive model-generated output, and treat the output as advice content related to self-brand formation.

The term “advice providing unit” refers to a functional component implemented by hardware, software, or a combination thereof, configured to convert advice content into a transmissible data format, send the advice content to a communication terminal using a communication protocol, and cause the advice content to be displayed on the communication terminal.

The term “iterative control unit” refers to a functional component implemented by hardware, software, or a combination thereof, configured to manage repeated processing cycles by receiving additional input from the user, triggering re-analysis of the input, reconstructing prompt sentences, and updating advice content over multiple interaction turns.

The term “support content related to personal self-expression” refers to generated information that assists a user in presenting, describing, or positioning self-related attributes, including communication styles, value propositions, and branding messages, in interpersonal or public contexts.

The term “self-brand formation” refers to a process in which a user builds, strengthens, or refines a personal brand or identity perception, through actions, communication, and presentation strategies that can be guided by advice content.

In one or more embodiments, a server cooperates with a terminal operated by a user to implement a computer-implemented system that generates personalized advice content for self-brand formation. The server executes a program stored in a non-transitory computer-readable medium and runs on general-purpose computing hardware, such as an x86-based or ARM-based server equipped with one or more central processing units (CPUs), one or more graphics processing units (GPUs), a main memory, and a network interface. The server may run an operating system such as a general-purpose server operating system, and may host a web server component (for example, a reverse proxy) and an application server component (for example, a runtime environment for server-side application code).

The server uses a communication network, such as the Internet or a mobile communication network, to exchange data with the terminal. The terminal is a general-purpose client-side device, such as a mobile device, a tablet, or a desktop device, that runs a messenger application or a similar communication application. The terminal includes a display, an input device such as a touchscreen or keyboard, a local processor, a memory, and a network interface for sending and receiving data using a secure communication protocol such as HTTPS.

The server uses a software stack that may include, but is not limited to, a web server component, an application framework (for example, a scripting-language-based framework), a natural language processing (NLP) library such as a statistical or neural-based text processing library, and a generative AI model deployed as a separate inference service. The generative AI model is typically a neural network-based language model of the Transformer architecture class, configured to accept a prompt sentence and to output generated text sequences representing advice content.

The server converts raw user input data into structured information. The user operates the terminal to input natural language messages describing interests, abilities, experiences, and emotions. The terminal transmits these messages to the server as text data. The server normalizes the text data by applying character encoding normalization, whitespace normalization, and symbol normalization, and then converts the normalized text into a structured data record. The structured data record may include fields corresponding to user identifiers, timestamps, language identifiers, and content fields. The server stores this structured data record in a memory or a storage subsystem for further processing.

The server uses an information analysis unit implemented as a software module that invokes NLP libraries and emotion analysis libraries. The server applies a tokenization algorithm to the normalized text to segment the text into tokens, and applies part-of-speech tagging and dependency parsing to identify grammatical roles. The server then uses feature extraction algorithms to identify user characteristics such as ability elements (for example, “design,” “leadership,” “communication”), preferences (for example, “prefers small teams,” “enjoys mentoring”), and behavior histories (for example, “led a project,” “presented in a meeting”). The server may use a statistical classifier or a neural network classifier to map phrases and sentences into semantic categories representing strengths, goals, and experience levels.

The server also uses an emotion analysis algorithm implemented as a separate neural network or a hybrid rule-based and machine learning module. The server may employ a recurrent or Transformer-based classifier trained with supervised learning to map input text into a distribution over emotion categories such as positive, negative, neutral, anxious, confident, or similar. The server computes an emotional state by evaluating the classifier output and may derive scalar sentiment scores or categorical emotion labels. The server then integrates these emotion features with the structured representation of user characteristics and user goals.

The server constructs a prompt sentence for the generative AI model using a prompt generation unit. The server does not simply concatenate raw user text; instead, the server forms an intermediate representation in which the extracted features are organized into categories, such as “Strengths,” “Experiences,” “Goals,” and “Emotion.” The server embeds this structured representation into a textual template that explicitly instructs the generative AI model how to interpret and use the information. For example, the server may generate a prompt sentence such as:
“You are a professional personal branding coach.
The user has the following profile:
   Strengths: design, UX design
   Experiences: has led small design tasks but not a full project
   Goals: wants to demonstrate leadership in the team
   Emotional state: feels uncertain about leading a full project
Based on this profile, generate concrete personal branding advice.
Propose strategies that leverage the user's design and UX skills.
Suggest specific actions they can take to show leadership in design projects.
Include recommendations on how to communicate their strengths and achievements to colleagues and stakeholders in everyday conversations and in online profiles.
User's own description:
‘I have strong design skills and I want to demonstrate leadership in my team. I am interested in UX design. I have led small design tasks, but not a full project.’”

In another example, the server may generate a refinement prompt sentence when additional user input is received:
“You previously generated personal branding advice for the following user profile:
Profile:
   Strengths: design, UX design
   Experiences: has led small design tasks but not a full project
   Goals: wants to demonstrate leadership in the team
   Emotional state: feels somewhat anxious about communication with non-designers
Previous advice:
‘[previous advice text]’
The user now provides additional preferences:
   ‘Please focus more on communication with non-designers. I prefer practical daily actions I can do in 10 minutes.’
Update and refine the advice based on these new preferences.
Emphasize short, daily communication behaviors that show leadership and make design ideas easy to understand for non-designers.”

The server uses the prompt generation unit to determine the arrangement and wording of the prompt sentence based on internal rules and model-specific constraints, such as token limits and instruction style. The server may store variant templates and select a template according to the length or complexity of the user profile, thus optimizing the prompt structure for inference efficiency.

The server sends the constructed prompt sentence to the generative AI model. The generative AI model is typically deployed on one or more GPU-enabled servers. The generative AI model has a Transformer-based architecture with multiple layers of self-attention and feed-forward sublayers. The model parameters, such as weight matrices and bias vectors, have been trained on large-scale text corpora using an unsupervised or semi-supervised objective, such as next-token prediction or masked token prediction. During training, the model minimizes a loss function such as the cross-entropy loss between predicted tokens and ground truth tokens, and updates weights using a gradient-based optimization algorithm such as stochastic gradient descent with momentum or an adaptive variant. The server may additionally perform fine-tuning on task-specific datasets that consist of user profile descriptions and corresponding advice texts, to specialize the model for personal branding guidance.

The server uses an inference engine to execute the trained generative AI model on the prompt sentence. The inference engine converts the prompt into token identifiers, processes the tokens through the model layers, and generates a sequence of token probabilities. The model then selects output tokens according to a decoding strategy such as greedy decoding, beam search, or nucleus sampling. The server receives the token sequence from the inference engine and decodes it into advice content text. This process is not a mere automation of human drafting; it uses internal representations in high-dimensional vector spaces and learned attention patterns that are not human-readable. The combination of feature-structured prompt sentences and neural decoding results in advice that is more coherent with user characteristics and emotion than advice produced from unstructured prompts.

The server post-processes the generated advice content by applying text normalization, segmentation into paragraphs, and filtering according to predetermined rules. The server may check for length constraints, remove incomplete sentences, and ensure that the advice is concise enough to be displayed on the terminal screen. The server converts the advice content into a structured data format and transmits it to the terminal using a secure communication protocol. The terminal displays the advice content in the messenger application or a dedicated advice view, using a layout that highlights different parts of the advice, such as key strategies, recommended actions, and communication phrases.

The server uses an iterative control unit to manage multiple interactions with the user. When the user inputs follow-up messages, the server merges these messages with the existing profile and dialogue history. The server updates the structured representation of user characteristics and user goals, recalculates the emotional state using the emotion analysis algorithm, and reconstructs the prompt sentence to include new constraints or preferences. By storing and referencing the dialogue history, the server avoids redundant analysis and can focus incremental processing on the new input, thereby reducing computational load. The server may also maintain a compact summary representation of the session in a vector or symbolic form, which is inserted into the prompt as contextual information, thus reducing token usage and communication bandwidth.

The server achieves technical improvements by organizing the data flow and the model invocation in a way that is optimized for machine processing rather than for direct human interpretation. In particular, by separating raw input collection, feature extraction, structured representation, prompt construction, and generative inference, the server is able to reuse extracted features across multiple turns, reduce the amount of redundant text passed to the generative AI model, and limit the context window usage. This reduces processing time on the inference hardware and lowers communication overhead between the application server and the model-serving endpoint.

The server also improves accuracy and stability of the generated advice by linking emotion analysis results to specific prompt fields. For example, when the emotion analysis algorithm detects high anxiety, the server modifies the prompt sentence to request more reassuring and stepwise guidance. This conditional prompt construction is specified algorithmically and can be applied consistently across sessions. This is different from human editing, because the server uses explicit mapping rules and threshold values derived from training data to determine how and when to adjust the prompt according to emotional state. This reduces variance in output quality and leads to more predictable behavior of the generative AI model.

The server further improves data management by using structured representations with fixed categories and fields, which simplifies indexing and retrieval of user sessions. When the server processes large numbers of user interactions, the structured records allow efficient database queries and caching strategies, such as partial re-use of previous analysis results. This leads to lower latency and improved scalability as compared to systems that store only raw text logs and must re-parse entire conversation histories for each new request.

In some embodiments, the server uses alternative NLP algorithms or emotion analysis algorithms. The server may use a pre-trained sentence embedding model to compute vector representations of user messages, and then cluster or classify these embeddings into categories representing user strengths and goals. The server may also use rule-based filters for domain-specific terms or a hybrid of keyword detection and neural classification to detect abilities and interests. These variations still rely on the same overall architecture of structured feature extraction, prompt sentence construction, and iterative generative inference.

In other embodiments, the generative AI model may be implemented using different neural architectures, such as a recurrent neural network with attention mechanisms or a hybrid architecture combining convolutional layers and self-attention layers. The training procedure may include data augmentation techniques, such as paraphrasing user profile texts or sampling alternative advice texts, to increase robustness. The server can adjust decoding parameters such as temperature or top-k threshold value to control randomness and diversity in the generated advice, enabling different modes such as “conservative” advice or “creative” advice.

The server may also control additional computing resources based on the structured representation. For instance, when the structured representation indicates a long and complex user profile, the server may allocate a higher compute tier or a GPU-backed model instance, while simpler profiles may be routed to a lighter model variant. This resource allocation decision is based on explicit computational criteria derived from the structured data rather than subjective human decision-making, thereby improving overall system throughput and efficiency.

The terminal participates in the implementation by formatting user input and output data in coordination with the server. The terminal may locally cache previous advice content and user input to reduce repeated transmission of redundant data. The terminal may also support user interface elements that enable the user to indicate emotional feedback (for example, selecting whether the advice was helpful or overwhelming), which the server can incorporate as additional features in the structured representation and in future prompt sentences. This feedback loop further optimizes the generative AI model's behavior without requiring changes to the underlying architecture for each individual user.

The user interacts with the system by entering natural language messages and reviewing the generated advice content. The user may iteratively refine the profile information and specify preferences, such as preferred communication style or time constraints for actions. The server integrates these refinements into the structured representation and into subsequent prompt sentences. As a result, the advice content becomes progressively more aligned with the user's needs, while the server continues to employ the same technical pipeline of analysis, feature extraction, prompt generation, and generative inference.

Overall, the described embodiments provide a concrete technical implementation in which the server executes specific algorithms and data transformations that leverage a generative AI model and a prompt sentence structure to improve the efficiency, accuracy, and stability of advice generation. The system does not simply automate human drafting; instead, it introduces a non-traditional, machine-centric pipeline with structured intermediate representations, emotion-aware prompt construction, and iterative control, thereby improving the functioning of the computer system itself in terms of processing speed, resource utilization, and output quality.

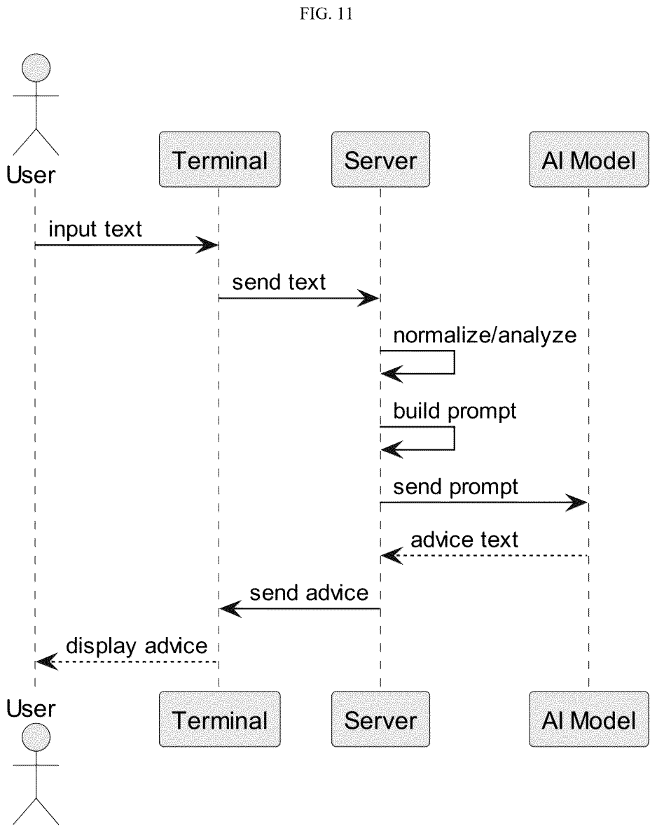

The following describes the processing flow using FIG. 11.

### Step 1:

The user operates the terminal to input profile information.

The user provides natural language text describing interests, abilities, experiences, and current feelings through an input field of a messenger application or similar user interface. The user, for example, enters sentences such as “I have strong design skills and I want to demonstrate leadership in my team,” and then presses a send button. The input of this step is raw text typed by the user, and the output is a message object held temporarily in the terminal's memory, containing the text string and local metadata such as a timestamp and a local user identifier.

### Step 2:

The terminal formats and transmits the user input to the server.

The terminal receives the message object from the user interface and converts the raw text and associated metadata into a structured request payload. The terminal, for example, constructs a record including fields such as user_id, message_text, timestamp, and language_code. The input of this step is the message object from Step 1, and the output is a serialized data payload that the terminal sends to the server via a secure protocol such as HTTPS. The terminal opens a network connection, sets request headers, places the serialized payload in the request body, and transmits the request to a designated server endpoint.

### Step 3:

The server receives and normalizes the raw text data.

The server accepts the incoming request through a network interface and passes the request to an application process. The server parses the serialized payload and extracts fields such as the user identifier and the message text. The input of this step is the serialized payload from the terminal, and the output is an internal data structure, such as an object or record, stored in server memory. The server normalizes the text portion by converting it to a standard character encoding, removing unsupported characters, and normalizing whitespace. The server then updates the internal record to store the normalized text, which serves as the basis for subsequent analysis.

### Step 4:

The server aggregates dialogue history and constructs a profile text.

The server retrieves previous messages and analysis results associated with the same user identifier from a database or cache. The input of this step is the current normalized text from Step 3 and any stored historical records for the user. The server concatenates the current text with selected previous texts and, optionally, with brief summaries of prior turns, to form a composite profile text. The server may apply rules to limit the length of the profile text, for example by discarding very old messages or by summarizing them. The output of this step is an aggregated profile text string that represents the user's current and past descriptions in a single coherent text segment.

### Step 5:

The server performs natural language preprocessing on the profile text.

The server uses a natural language processing library to conduct tokenization, sentence segmentation, part-of-speech tagging, and dependency parsing on the aggregated profile text. The input of this step is the profile text from Step 4. The server computes token sequences, syntactic structures, and preliminary semantic markers (for example, noun phrases and verb phrases). The output is an enriched representation that includes the original text together with token indices, syntactic tags, and a list of candidate phrases representing interests, abilities, experiences, and goals.

### Step 6:

The server extracts user characteristics, goals, and behavior features.

The server applies feature extraction algorithms to the enriched representation from Step 5. The input of this step is the tokenized and parsed profile text with candidate phrases. The server uses a trained classifier or rule set to map phrases to categories such as strengths, experiences, preferences, and goals. The server may, for example, detect that “design skills” belongs to a strength category and “demonstrate leadership” belongs to a goal category. The server calculates feature vectors or symbolic labels representing these categories. The output of this step is a structured feature record containing lists of strengths, goals, experience elements, and preference indicators.

### Step 7:

The server analyzes the emotional state of the user.

The server invokes an emotion analysis algorithm, such as a neural classifier trained on emotion-labeled text. The input of this step is the profile text from Step 4 and optionally the individual recent message from the user. The server converts the text into an embedding vector using a pre-trained encoder and feeds the embedding into the classifier. The classifier produces probabilities for emotion categories (for example, confident, anxious, neutral) and optionally a sentiment score. The server then determines an emotional state label based on threshold rules or maximum probability. The output of this step is an emotion descriptor, such as a categorical label and associated confidence score, which is appended to the structured feature record.

### Step 8:

The server constructs a structured profile representation.

The server combines the feature record from Step 6 and the emotional state descriptor from Step 7 into a single structured profile object. The input of this step is the list of extracted strengths, goals, experiences, preferences, and the emotional state label. The server organizes these elements into predefined fields such as “Strengths,” “Experiences,” “Goals,” “Preferences,” and “Emotion.” The output is a structured profile representation that can be serialized or passed to subsequent modules without re-parsing the original text.

### Step 9:

The server generates a prompt sentence for the generative AI model.

The server uses the structured profile representation from Step 8 and a stored template selected based on system rules. The input of this step is the structured profile and the template definition. The server inserts field values (for example, lists of strengths and goals) into designated positions in the template, and appends the user's own description as a quoted segment. The server may also include specific instructions such as “generate concrete personal branding advice” or “focus on interpersonal communication with non-experts.” The output of this step is a complete prompt sentence in natural language, for example:
“You are a professional personal branding coach.
The user has the following profile:
   Strengths: design, UX design
   Experiences: has led small design tasks but not a full project
   Goals: wants to demonstrate leadership in the team
   Emotional state: feels uncertain about leading a full project
Based on this profile, generate concrete personal branding advice.
Propose strategies that leverage the user's design and UX skills.
Suggest specific actions they can take to show leadership in design projects.
Include recommendations on how to communicate their strengths and achievements to colleagues and stakeholders in everyday conversations and in online profiles.
User's own description:
   ‘I have strong design skills and I want to demonstrate leadership in my team. I am interested in UX design. I have led small design tasks, but not a full project.’”

### Step 10:

The server sends the prompt sentence to the generative AI model and obtains generated advice.

The server takes the prompt sentence from Step 9 and encodes it into token identifiers according to the vocabulary of the generative AI model. The input of this step is the prompt sentence string. The server calls an inference service, providing the token sequence and generation parameters such as maximum output length and temperature. The generative AI model processes the token sequence through its neural network layers and returns a sequence of output token identifiers. The output of this step is a decoded advice text, which the server obtains by converting the token identifiers back into a natural language string.

### Step 11:

The server post-processes the generated advice content.

The server receives the raw advice text from Step 10 and applies formatting and filtering rules. The input of this step is the model-generated text sequence. The server removes unnecessary leading or trailing whitespace, divides the text into paragraphs or bullet-like segments, and may enforce a maximum character or sentence limit to ensure display suitability on the terminal. The server may also correct obvious formatting anomalies, such as duplicated headings. The output of this step is a cleaned and formatted advice text ready for delivery.

### Step 12:

The server packages and transmits the advice to the terminal.

The server creates a response object containing the formatted advice text from Step 11, together with metadata such as timestamps and identifiers. The input of this step is the formatted advice text. The server serializes this response object and sends it as a response to the terminal over the same secure communication channel. The output of this step is a transmitted response payload that arrives at the terminal.

### Step 13:

The terminal receives and renders the advice for the user.

The terminal accepts the response payload from the server, deserializes it, and extracts the advice text. The input of this step is the serialized response payload from Step 12. The terminal creates a display element, such as a chat bubble or a dedicated advice panel, and inserts the advice text into a text view. The terminal applies local styling and arranges the new element in the conversation view. The output of this step is a visual presentation of the advice on the terminal display, which the user can read and interact with.

### Step 14:

The user reviews the advice and optionally provides additional input.

The user reads the advice presented on the terminal and evaluates it in light of personal objectives and emotional state. The input of this step is the displayed advice text. The user may provide additional messages, such as “Please focus more on communication with non-designers,” or “I prefer daily actions I can do in 10 minutes.” The user enters these messages into the input field and sends them through the terminal. The output of this step is new raw text input that returns to Step 1 and triggers another iteration of the processing flow, in which the server treats the additional text as incremental information for updating the structured profile and prompt sentence.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems and personal branding support systems suffer from several technical limitations when applied to real-time, in-store interactions between a staff member and a customer. Typical systems either rely on static rule-based engines or batch-type data analysis, and thus cannot adapt the content and style of recommendations dynamically in response to continuously changing conversational context and user emotion. As a result, such systems often generate generic or context-insensitive recommendations, require substantial manual intervention by the staff, and fail to take advantage of advances in generative artificial intelligence models that can flexibly synthesize text based on rich context.

In addition, existing architectures generally separate the acquisition of multimodal customer information on a terminal device from the generation of proposals on a remote computation resource, without providing an integrated mechanism for (i) transforming noisy, real-world dialog data and sensor data into structured prompt sentences suitable for a generative AI model, (ii) structuring the generated text back into machine-usable proposal data consistent with inventory or service constraints, and (iii) adjusting both the content and tone of the generated proposals in real time based on detected emotional states. This leads to inefficiencies in data processing pipelines, increased latency, and unstable quality of proposals.

Furthermore, many systems treat emotional analysis and recommendation generation as separate, loosely coupled processes. Emotional analysis results, when available, are often not used to dynamically modify the prompt level instructions to a generative AI model, or to rewrite recommendation scripts at the output stage. Consequently, the system cannot effectively tailor the linguistic style and explanatory depth of proposals to the emotional state of the user or the customer, which reduces the usability and effectiveness of computer-assisted recommendation.

There is therefore a need for an improved computer-implemented system and server-side processing architecture that: (i) tightly integrates multimodal data capture on a terminal, centralized preprocessing and normalization on a server, and interaction with a generative AI model using dynamically constructed prompt sentences; (ii) converts unstructured AI outputs into structured proposal information aligned with inventory or service data; and (iii) uses an emotion analysis algorithm in a feedback loop to adapt both the prompts and the generated proposals in real time. Such a system would improve the technical functioning of recommendation and branding support platforms by optimizing data flows, reducing manual operations, and enabling more context-aware and emotionally adaptive generation of proposal information.

The specific processing by the specific processing unit 290 of the data processing device 12 in Application Example 1 is realized by the following means.

The present invention provides a server comprising a processor configured to receive, from a terminal, information and dialog information acquired from a user, preprocess the information and the dialog information, construct a prompt sentence based on the preprocessed information and the dialog information, input the prompt sentence into a generative artificial intelligence model so as to instruct the generative artificial intelligence model to generate support for personal image formation and proposals for goods or services, obtain proposal content output from the generative artificial intelligence model, compare the proposal content with inventory information or available service information, generate proposal information to be output to the terminal by formatting the proposal content in accordance with the inventory information or the available service information, analyze an emotional state of the user or a customer by using an emotion analysis algorithm based on data acquired via the terminal, and adjust at least one of content and expression style of the prompt sentence or the proposal information in accordance with the emotional state, while transmitting and receiving, via a communication network, digital information and the proposal information between the terminal, the server, and the generative artificial intelligence model. This enables an integrated and technically improved pipeline in which multimodal customer data from the terminal is transformed into optimized prompt sentences for the generative AI model, AI-generated text is normalized into structured proposal information consistent with resource constraints, and both the prompts and the resulting proposals are dynamically adapted in real time to the emotional state of the user or customer, thereby enhancing the effectiveness, responsiveness, and computational efficiency of computer-based recommendation and personal branding support.

The term “processor” refers to a hardware computing element, such as a central processing unit or a programmable logic device, configured to execute instructions stored in a memory to perform the functions described herein.

The term “terminal” refers to an information processing device operated by a user or a staff member, including at least one input unit and at least one display unit, and configured to acquire information from a user or a customer and to communicate with a server via a communication network.

The term “server” refers to a computational apparatus, which may be implemented by one or more physical or virtual machines, configured to perform centralized processing of data received from one or more terminals and to communicate with an external or internal generative artificial intelligence model.

The term “generative artificial intelligence model” refers to a machine learning model configured to generate text or other data in response to an input prompt, based on parameters trained on example data, and capable of synthesizing recommendations or explanatory sentences from contextual information.

The term “prompt sentence” refers to a text sequence or structured text input, provided to the generative artificial intelligence model, that describes context, constraints, or instructions for controlling the content, style, and scope of output generated by the generative artificial intelligence model.

The term “proposal content” refers to information output from the generative artificial intelligence model that includes one or more candidate items, such as goods or services, and associated explanatory text or guidance, prior to being formatted or filtered by the server.

The term “proposal information” refers to structured data generated on the server based on the proposal content, including identifiers of candidate items, descriptive texts, conversation guide sentences, and any additional metadata suitable for display and use on a terminal.

The term “inventory information” refers to data representing the availability, identification, attributes, and pricing of goods or services that can be provided by a seller or service provider, stored in a storage resource accessible to the server.

The term “service information” refers to data representing types, conditions, and availability of services that can be provided to a user or a customer, including constraints such as time, location, and capacity.

The term “dialog information” refers to data representing a sequence of utterances or interactions between a user or a staff member and a customer, including transcribed text of spoken language and, optionally, associated timestamps or context labels.

The term “digital information” refers to data represented in a machine-readable format, including text, numeric values, metadata, or encoded audio or image data, that is processable by the processor of the terminal or the server.

The term “emotion analysis algorithm” refers to a computational procedure, implemented as software or a combination of software and hardware, configured to estimate an emotional state from input data such as text, audio, image, or physiological signals.

The term “emotional state” refers to a category or parameterization of affective condition, such as positive, negative, neutral, or more specific emotions, derived by the emotion analysis algorithm from data related to a user or a customer.

The term “personal image formation” refers to a process of generating or supporting communication content, including wording, tone, and presentation style, that contributes to the formation or reinforcement of a desired personal brand or public persona of a user.

The term “attribute information” refers to profile data associated with a user or a customer, including at least one of demographic information, preference information, or role information, which may be used to tailor recommendations or communication style.

The term “interest information” refers to data indicating topics, product categories, or activities that a user or a customer has expressed interest in, as derived from dialog information, behavior records, or stored preferences.

The term “skill information” refers to data representing abilities, proficiencies, or expertise levels of a user or a customer, which can be used to adjust the complexity or specificity of generated recommendations or explanatory content.

The term “experience information” refers to data representing past activities or histories, including prior purchases, previous usage of services, or interaction history, associated with a user or a customer.

The term “past dialog history information” refers to stored dialog information from previous interactions between a user or a staff member and a customer, which may be referenced to provide continuity and context to new recommendations.

The term “conversation guide sentence” refers to a sentence or phrase generated or selected by the system for use by a user or a staff member when speaking to a customer, and designed to assist in explaining or presenting goods or services.

The term “candidate goods” refers to goods selected or suggested by the system as potential options for recommendation to a customer, prior to final selection or presentation.

The term “candidate services” refers to services selected or suggested by the system as potential options for recommendation to a customer, prior to final selection or presentation.

The term “structured information” refers to data organized into a predefined format, such as records, fields, or key-value pairs, enabling deterministic parsing and processing by software components.

The term “personal image formation policy information” refers to configuration data representing preferred tone, style, and communication guidelines associated with a user's desired personal image, which is referenced when generating or modifying conversation guide sentences.

The term “communication network” refers to any wired or wireless data communication infrastructure, including local area networks, wide area networks, or public networks, that allows data exchange between the terminal, the server, and the generative artificial intelligence model.

The term “display unit” refers to a hardware component capable of presenting visual information to a user, such as a head-mounted display, a screen, or a projection surface, controlled by the terminal.

The term “audio input” refers to functionality or hardware, such as a microphone and associated signal processing, for capturing sound data from the environment or from a user or customer.

The term “image input” refers to functionality or hardware, such as a camera and associated signal processing, for capturing still images or video data from the environment or from a user or customer.

In one embodiment, a server cooperates with at least one terminal operated by a user to implement a system for generating, adapting, and delivering proposals and personal image formation support using a generative AI model and emotion analysis. The server is implemented as one or more computing devices, for example, a rack-mounted computer in a data center or a virtual machine instance on a cloud computing platform. The server includes at least one processor, a memory storing executable instructions and data structures, and a communication interface. The terminal is implemented as an information processing device, such as smart glasses, a smartphone, or a tablet computer, including a display unit, a microphone, a camera, and a wireless communication module.

The server uses an operating system such as a general-purpose server operating system and executes an application layer component using, for example, a runtime environment such as a scripting or application framework. The server communicates with the terminal via a communication network using a protocol such as HTTPS. The terminal uses an operating system such as a mobile operating system and executes an application configured to capture audio and image data, display proposal information, and exchange structured digital information with the server.

The terminal acquires audio data of a dialog between the user and a customer using the microphone, and acquires image data of the customer or physical objects such as products or shelves using the camera. The terminal applies a speech recognition process to the audio data by invoking a speech recognition service. For example, the terminal transmits a compressed audio stream to a remote speech recognition server using HTTPS, and receives text data representing a transcription of the dialog. The terminal also applies a basic feature extraction process to the image data, such as detecting the presence of objects or reading labels using a vision algorithm implemented by an image analysis library.

The terminal converts the transcription and the extracted image features into a structured digital representation. The terminal generates dialog information including a sequence of utterances with timestamps, speaker labels, and tokens, and includes metadata such as store identifier, user identifier, and device identifier. The terminal transmits this dialog information to the server using a request that encapsulates the data in a predefined hierarchical structure, for example, a nested set of fields representing user attributes, customer interests, recognized objects, and context labels.

The server receives the dialog information and stores it in a data storage resource, such as a relational database or a document database. The server normalizes the text data by applying tokenization, lowercasing, and spelling correction using a natural language processing library. The server extracts entities such as product categories, budget ranges, and activity types using a named entity recognition model. The server then associates the extracted entities with inventory information stored in a database. The inventory information includes, for each item, an identifier, category, price, weight, stock quantity, and descriptive attributes.

The server constructs a prompt sentence to be used as input to the generative AI model. The server generates the prompt sentence based on the preprocessed dialog information, the extracted entities, and the inventory information. In one example, the server generates the following prompt sentence:
“The customer is interested in outdoor gear and wants equipment for weekend camping. The customer is a beginner and has a budget of around 300 dollars. Based on the current store inventory, which includes tents, sleeping bags, backpacks, and lanterns with attributes such as price, weight, and stock status, please propose 3 to 5 suitable products and generate short explanation sentences that the store staff can say directly to the customer. Use a friendly and professional tone.”

In another example, the server generates the following prompt sentence for refined recommendations:
“The customer is interested in outdoor gear for weekend camping and prefers lightweight equipment suitable for travel by public transport. The budget is around 300 dollars. Based on the updated conditions and the current inventory, refine the previous proposal and suggest 3 products with the best balance of low weight, reasonable price, and ease of use, and provide a one-sentence selling point for each.”

The server inputs the prompt sentence into the generative AI model. The generative AI model is implemented as a neural network-based language model, for example, a transformer architecture having multiple layers of self-attention and feedforward units. The model includes an embedding layer that converts tokens of the prompt sentence into dense vectors, a stack of attention blocks that compute contextualized representations of each token, and an output layer that produces probability distributions over possible next tokens. The generative AI model has been trained on a large corpus of text data using a loss function such as cross-entropy between predicted token distributions and target tokens. During training, the model parameters, including weights and biases in the attention and feedforward layers, are updated using gradient descent optimization with backpropagation. The training process may use techniques such as mini-batch training, adaptive learning rate optimization, and regularization.

The server interacts with the generative AI model by providing the prompt sentence and control parameters such as a temperature value, a maximum number of output tokens, and a decoding strategy such as beam search or top-k sampling. The generative AI model generates a sequence of tokens representing proposal content, which may contain product suggestions, explanation sentences, and conversational phrases. The server decodes these tokens into text and segments the text into separate recommendation units using delimiter patterns or heuristic rules.

The server converts the generated text into structured proposal information. For each recommended item described in the text, the server identifies product names or generic item types by matching against the inventory database using a similarity measure such as cosine similarity on vectorized representations or string matching with normalization. The server retrieves the corresponding item records from the inventory information and builds a proposal entry containing the item identifier, item category, price, and a conversation guide sentence derived from the generated text. The server discards or replaces any item that is not present in the current inventory or is out of stock. This structuring and validation step transforms unstructured AI output into data that can be reliably used by downstream components.

The server analyzes an emotional state of the user or the customer. The server receives features related to emotion from the terminal, such as prosodic features derived from audio (e.g., pitch, intensity), facial expression features detected from image data, or lexical cues from the text of the dialog. The server applies an emotion analysis algorithm implemented as a trained classifier, which may be a neural network, a support vector machine, or another statistical model. For example, the server may use a recurrent neural network or a transformer-based classifier that takes token embeddings of the dialog text as input, and outputs probability scores for predefined emotion categories. The classifier is trained using labeled datasets with an objective function such as cross-entropy over emotion labels. During training, the classifier updates its weights through gradient-based optimization, and may employ techniques such as data augmentation, dropout, and class balancing to improve robustness.

The server uses the estimated emotional state as a control signal to modify both the prompt sentence and the proposal information. When constructing a new prompt sentence, the server can include explicit instructions regarding tone or level of detail, such as:
“The customer seems anxious and uncertain based on the recent dialog. Please propose 3 easy-to-understand and reassuring explanations for the recommended items, avoiding technical jargon and emphasizing safety and simplicity.”

The server can also apply a rewriting process to the conversation guide sentences contained in the proposal information. In one embodiment, the server passes each guide sentence, along with a description of the desired tone and the user's personal image formation policy, to a generative or discriminative rewriting module. The module can be implemented as a smaller language model or a rule-based text transformation engine. The server uses this module to adjust word choice, sentence length, and politeness level while preserving the core content. This results in technically controlled modification of output text in a way that is difficult to perform manually in real time.

The server then transmits the finalized proposal information to the terminal. The terminal parses the received data and renders the proposals on the display unit. The terminal may arrange the proposals in a list, show item names and prices in a prominent manner, and show the conversation guide sentences in a readable font size. The terminal can also highlight items that best match the customer's stated constraints or emotional state. The user views the display and uses the guide sentences as a basis for verbally presenting the recommendations to the customer.

The server improves computer technology in several ways. First, the server organizes dialog information, inventory information, and emotional state into a specific data structure optimized for prompt construction and AI output structuring. This reduces redundant network traffic and unnecessary token usage, thereby decreasing communication load and computation time of the generative AI model. Second, the server applies a non-conventional pipeline in which the generative AI model is not used as a monolithic black box, but is constrained and guided through dynamically constructed prompt sentences that incorporate structured inventory and emotion data. This enables the model to generate outputs that already respect resource constraints, reducing the need for expensive post-filtering operations and improving end-to-end latency.

Third, the server performs a two-stage processing of AI-generated text: an initial generation phase followed by a structured mapping and rewriting phase. In this architecture, the server uses deterministic matching and formatting algorithms to convert text into structured records, enforce consistency with inventory data, and apply tone adjustment rules. This structured post-processing significantly reduces error rates such as proposing unavailable products, and improves the precision of recommendations. The combination of generative and deterministic processing modules constitutes an improvement over systems that rely solely on rule-based engines or unstructured AI output.

Fourth, the server implements emotion-adaptive processing. By integrating emotion analysis results directly into the construction of prompt sentences and the rewriting of proposal text, the server controls the behavior of the generative AI model in a way that conventional static prompts do not. The server modifies parameters or explicit instructions within the prompt sentence based on emotion scores, which leads to different token distributions in the model's internal computation and produces outputs that are better aligned with the current context. This feedback loop between emotion analysis and generation reduces the need for repeated manual rephrasing by the user and allows the system to achieve improved responsiveness and user satisfaction.

The terminal contributes to technical effects by performing on-device preprocessing and compression of dialog information and image features before transmission. The terminal can remove redundant segments, aggregate utterances, and encode features in a compact form. This reduces bandwidth usage and lowers latency. In some embodiments, the terminal can perform on-device keyword extraction using a lightweight neural model with quantized weights to minimize computational load. This edge-side processing offloads some work from the server and improves scalability when multiple terminals are in operation.

The user interacts with the system by speaking with the customer and by optionally selecting or confirming proposals on the terminal. The user can request refinement of recommendations by initiating another round of dialog, which the terminal and server handle through the same data processing pipeline. For example, if the customer later indicates that they will camp in colder seasons, the server can generate a new prompt sentence such as:
“The customer previously received recommendations for weekend camping gear. The customer has now stated that camping will be in colder seasons. Please adjust the previous proposal to prioritize items suitable for low temperatures, such as winter-ready sleeping bags and insulated mats, while remaining within a budget of around 300 dollars.”

The server processes this additional context, invokes the generative AI model with the updated prompt sentence, and supplies refined proposal information back to the terminal. The iterative nature of this process allows the system to maintain a continuous, context-aware, and emotion-sensitive recommendation session.

In alternative embodiments, the server can use different neural network architectures for the generative AI model and the emotion analysis algorithm. The generative AI model may be implemented as a sequence-to-sequence model with encoder-decoder architecture, while the emotion analysis algorithm may be implemented as a convolutional neural network for spectrogram features of audio, or as a multimodal model combining text and image features. The server can also store different prompt templates and select an appropriate template based on scenario type, such as initial consultation, follow-up visit, or after-sales support.

In another variation, the terminal can be a head-mounted display device with gesture detection capability. In this case, the terminal can detect user gestures, such as swipes or taps in mid-air, to navigate through proposals. The terminal can also adjust brightness and layout based on ambient lighting measured by sensors, thereby improving readability and reducing user fatigue. This physical adaptation of display behavior, controlled by the terminal based on proposal information and sensor data, further ties the abstract data processing to real-world device control.

By employing these configurations, the server, the terminal, and the generative AI model cooperate to implement a system that goes beyond simple automation of human decision-making. The system defines specific data structures for dialog information and proposal information, uses specialized neural architectures with trained parameters and defined loss functions, and applies non-conventional processing flows that integrate emotion analysis into prompt construction and output rewriting. As a result, the system achieves improvements in processing speed, recommendation precision, communication efficiency, and robustness of proposal generation, thereby constituting a technical improvement in the operation of computer-based recommendation and personal image formation systems.

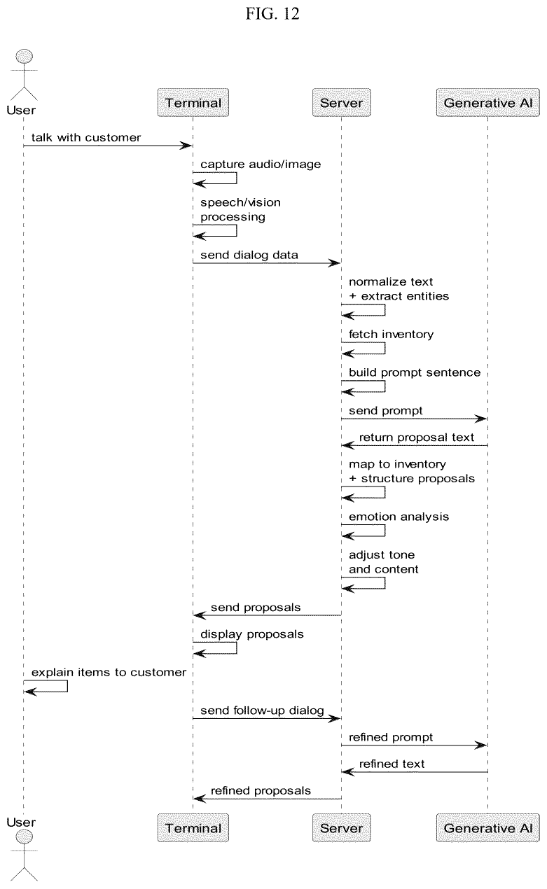

The following describes the processing flow using FIG. 12.

### Step 1:

The user initiates an interaction with a customer and speaks naturally.

The terminal receives, as input, analog audio of the dialog through a microphone and analog image signals through a camera.

The terminal converts the analog audio into digital audio samples using an analog-to-digital converter and segments the samples into short frames. The terminal also converts the analog image signals into digital image frames.

The terminal outputs digitized audio data and digitized image data tagged with timestamps.

### Step 2:

The terminal uses the digitized audio data as input to a speech recognition process.

The terminal transmits the audio frames to a speech recognition service, receives a text transcription, and aligns recognized words with timestamps. The terminal may remove noise and normalize volume before transmission.

The terminal outputs dialog text, segmented into utterances with speaker labels (user or customer), and associated timestamps.

### Step 3:

The terminal uses the digitized image data as input to a basic vision analysis process.

The terminal applies an object detection or feature extraction algorithm to identify visible product regions, labels, or environmental cues, such as shelves or signage. The terminal converts these findings into symbolic descriptors (for example, “camping section,” “tent shelf”).

The terminal outputs image feature data that associates descriptors with locations and timestamps.

### Step 4:

The terminal integrates the dialog text and image feature data.

The terminal uses, as input, the utterance list, timestamps, user identifier, device identifier, and image descriptors. The terminal groups utterances and image descriptors that occur within a defined time window and assigns context tags such as “interest inquiry,” “budget statement,” or “product focus.”

The terminal outputs dialog information as a structured digital record, including utterances, context tags, recognized interest keywords, and linked image descriptors.

### Step 5:

The terminal prepares a transmission package to the server.

The terminal uses, as input, the structured dialog information and metadata such as store identifier and session identifier. The terminal serializes this information into a hierarchical data structure and adds authentication data.

The terminal outputs a request message and transmits it to the server over a secure communication channel.

### Step 6:

The server receives and validates the request message.

The server uses, as input, the request message containing dialog information, metadata, and authentication data. The server verifies the authentication token, checks the integrity of the structure, and discards malformed or unauthorized requests.

The server outputs validated dialog information and stores a copy in a data storage resource associated with a conversation identifier.

### Step 7:

The server performs text normalization and entity extraction.

The server uses, as input, the dialog text and context tags from the validated dialog information. The server tokenizes the text, normalizes case, corrects common spelling errors, and removes noise tokens. The server applies an entity recognition model to identify entities such as product categories, budgets, time expressions, and activity types.

The server outputs normalized text and an entity list, where each entity is associated with a type, a span in the text, and a confidence score.

### Step 8:

The server links entities to inventory information and service information.

The server uses, as input, the entity list and a database of inventory information and service information. The server performs matching by comparing entity strings to item names, categories, and attributes using similarity measures and lookup indices. The server filters inventory entries to those relevant to the identified categories and within any budget constraints mentioned in the dialog.

The server outputs a set of candidate inventory records and a filtered context that describes the relevant resource space for proposal generation.

### Step 9:

The server constructs a prompt sentence for the generative AI model.

The server uses, as input, the normalized text, the entity list, and the filtered inventory context. The server selects a prompt template based on scenario type (for example, initial recommendation or refinement) and fills template slots with actual values such as interest category, experience level, budget, and inventory summary. The server may also include instructions about tone and number of items to propose.

The server outputs a prompt sentence in natural language. For example, the server may output:
“The customer is interested in outdoor gear and wants equipment for weekend camping. The customer is a beginner and has a budget of around 300 dollars. Based on the current store inventory, which includes tents, sleeping bags, backpacks, and lanterns with attributes such as price, weight, and stock status, please propose 3 to 5 suitable products and generate short explanation sentences that the store staff can say directly to the customer. Use a friendly and professional tone.”

### Step 10:

The server invokes the generative AI model with the prompt sentence.

The server uses, as input, the prompt sentence and model control parameters such as temperature, maximum output length, and decoding strategy. The server encodes the prompt sentence into tokens, submits these tokens to the generative AI model, and requests a completion.

The server outputs raw generated text from the generative AI model representing proposal content that includes product suggestions and explanatory sentences.

### Step 11:

The server structures the proposal content.

The server uses, as input, the raw generated text and the candidate inventory records. The server parses the generated text, identifies separate recommendation units (for example, by detecting list markers or sentence boundaries), and attempts to map each recommended item to an inventory record by comparing names and attributes. When multiple matches are possible, the server selects the record with the highest similarity score.

The server outputs proposal information in a structured form, where each proposal entry includes an item identifier, item attributes, and a conversation guide sentence derived from the generated text.

### Step 12:

The server performs consistency checks and refinement.

The server uses, as input, the structured proposal information and the current inventory or service constraints (stock quantity, availability windows, or service capacity). The server removes entries that reference unavailable items or invalid services and, if necessary, replaces them by selecting alternative items from the candidate inventory records. The server may reorder proposals based on relevance or margin criteria.

The server outputs refined proposal information that is guaranteed to be consistent with current resource constraints.

### Step 13:

The server estimates an emotional state of the user or customer.

The server uses, as input, emotion-related features provided by the terminal, such as acoustic features (pitch, energy), lexical features (sentiment-bearing words), and visual features (facial expression indicators). The server applies an emotion analysis algorithm, for example, a trained classifier that converts these features into probabilities over emotion categories. The server may aggregate features over a time window and compute a dominant emotional state.

The server outputs an emotional state label and associated confidence values.

### Step 14:

The server modifies the prompt sentence generation rules and guide sentences based on the emotional state.

The server uses, as input, the emotional state label, personal image formation policy information associated with the user, and the structured proposal information. The server adjusts parameters for future prompt construction, such as specifying a more reassuring, concise, or energetic tone. The server also passes each conversation guide sentence through a rewriting component that takes the target tone and policy information as conditions and transforms the text by substituting words, adjusting sentence length, and modifying politeness level.

The server outputs emotion-adapted proposal information containing updated conversation guide sentences and updated control parameters for subsequent prompts.

### Step 15:

The server transmits the emotion-adapted proposal information to the terminal.

The server uses, as input, the finalized proposal information and the session identifier. The server encapsulates the proposal entries into a response message and sends it via the communication interface over the network to the terminal.

The server outputs a network response that delivers all proposal entries and related metadata to the terminal.

### Step 16:

The terminal receives and renders the proposal information.

The terminal uses, as input, the response message containing the proposal entries. The terminal parses the message, extracts item identifiers, prices, categories, and conversation guide sentences, and maps any item identifiers to local presentation resources such as icons or thumbnails. The terminal arranges the proposals in an ordered list or grid layout, emphasizes key attributes such as price or weight, and displays the conversation guide sentences in a readable format adapted to the display unit.

The terminal outputs visual content on the display unit and interaction elements that allow the user to navigate the proposals.

### Step 17:

The user reviews and uses the proposals in real time.

The user uses, as input, the visual content displayed on the terminal. The user reads the conversation guide sentences and combines them with their own knowledge to speak to the customer. The user may select a specific proposal on the display to view more detailed attributes or to mark it as chosen.

The user outputs verbal recommendations to the customer and may trigger further interaction, such as asking clarifying questions or confirming preferences.

### Step 18:

The terminal captures follow-up dialog and context updates.

The terminal uses, as input, new audio and image data generated during continued conversation, as well as user interactions such as selections or confirmations on the display.

The terminal repeats the audio digitization and speech recognition, updates the dialog information structure with new utterances and context tags, and records any selection signals as constraints (for example, “tent selected,” “budget increased”).

The terminal outputs updated dialog information and constraint data, which it transmits to the server for iterative refinement.

### Step 19:

The server performs iterative refinement of proposals using updated context.

The server uses, as input, the updated dialog information, constraint data, and previous proposal information. The server updates the entity list, applies any new constraints (for example, seasonality or transportation method), and constructs a new prompt sentence that references both the prior recommendations and the new information. The server again invokes the generative AI model, structures the resulting text, and repeats the emotion-adaptive rewriting process.

The server outputs refined proposal information that reflects the latest user and customer context and returns it to the terminal.

### Step 20:

The system converges to a finalized recommendation set.

The user, the terminal, and the server use, as input, the continuously refined proposal information and interaction signals. Through repeated cycles, the server narrows down items, the terminal presents progressively more tailored proposals, and the user confirms selections with the customer. When the customer accepts specific items or services, the terminal may record a final selection signal, and the server may log this as part of experience information and past dialog history for future sessions.

The system outputs, as a final result, selected items or services and associated dialog records, which can be used in subsequent interactions to construct more accurate prompt sentences and to further improve the generative AI model's effectiveness through additional training or fine-tuning processes executed outside the real-time path.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional messaging systems and personal-branding support tools are typically implemented as separate components that are loosely coupled at the application level. In such arrangements, a communication platform merely transmits and stores user messages, while a separate content-assistance engine or generative model provides generic suggestions without deep integration into message routing, session management, or user-context handling. As a result, the underlying computer system fails to exploit user-specific context, fails to manage generative AI interactions efficiently, and imposes redundant data transfers and processing overhead across disparate services.

In particular, conventional systems do not maintain a unified, machine-usable linkage between (i) user authentication and connection state, (ii) message delivery management, and (iii) generative AI interactions driven by prompt sentences that reflect detailed user context and emotional state. Because these elements are processed in isolation, computing resources are wasted on repetitive retrieval and re-parsing of user information, and the generative AI model is invoked with incomplete or poorly structured prompt sentences. This leads to increased latency, inconsistent output quality, and excessive load on processing and storage resources.

Furthermore, many existing systems do not log, in a systematic and structured manner, the association between each prompt sentence, the corresponding AI output, and the message-delivery events within a single server-controlled datastore. Without such association, the system cannot perform effective feedback-based optimization of prompts or delivery behavior at the infrastructure level. This lack of integrated history management prevents the server from adaptively improving the way prompt sentences are generated and from optimizing the timing and content of AI-assisted messages for different users.

In addition, conventional architectures generally treat online/offline detection and message queuing as independent from AI-assisted message generation. As a result, there is no coherent mechanism in which the same server-level logic that manages Web-based message routing and queueing also orchestrates when and how generative AI is used to shape messages presented to users. This separation tends to increase complexity in the client applications, forces clients to handle orchestration logic, and undermines scalability and maintainability of the overall computer system.

Accordingly, there is a need for a computer-implemented system and server architecture that tightly integrates (i) authentication and connection-state management, (ii) message storage and routing, and (iii) context-aware interaction with a generative AI model via structured prompt sentences, in order to reduce redundant processing, improve response latency, and enhance the quality and consistency of AI-assisted personal-branding messages. There is also a need for a system that maintains unified history information linking prompt sentences, AI outputs, and user-identifying metadata so that the server can automatically refine prompt-generation strategies and thereby improve the operation of the computer system itself.

The specific processing by the specific processing unit 290 of the data processing device 12 in Example 2 is realized by the following means.

The present invention provides a server comprising a processor and a storage device, the processor being configured to execute integrated authentication, context management, AI interaction, and message-routing operations on behalf of multiple communication terminals so as to improve the efficiency and technical performance of a messaging and personal-branding support system. This enables the server to reduce redundant data processing, to generate and apply context-rich prompt sentences to a generative AI model with lower latency and higher output relevance, and to optimize message delivery and AI usage based on unified history information stored in the storage device.

The term “system” refers to a computerized arrangement including at least one processor and at least one storage device, and optionally one or more communication terminals, configured to execute the functions described in the claims.

The term “processor” refers to one or more hardware processing units, such as a central processing unit or a microprocessor, capable of executing computer-readable instructions to perform data processing, control, and communication operations.

The term “storage device” refers to one or more non-transitory computer-readable media, such as semiconductor memory, magnetic storage, or optical storage, configured to store programs, user data, message data, connection information, and history information.

The term “communication terminal” refers to a user-operated electronic device, such as a smartphone, tablet, or personal computer, that executes a communication application and exchanges data with the server over a communication network.

The term “communication application” refers to an application program or web-based application executed on a communication terminal that provides a user interface for composing, transmitting, receiving, and displaying message information.

The term “user” refers to a human operator who interacts with the communication application and the system to send and receive messages and to obtain personal-branding assistance.

The term “authentication information” refers to data used to verify the identity of a user, such as a user name, password, token, or other identification credentials transmitted from the communication terminal to the server.

The term “user information” refers to information stored in the storage device for identifying and managing a user, including but not limited to identifiers, authentication credentials, profile information, and account status information.

The term “authentication process” refers to a series of operations in which the processor compares authentication information received from a communication terminal with user information stored in the storage device to determine whether access should be granted.

The term “screen display data” refers to structured data, such as layout information and content information, generated by the processor and transmitted to the communication terminal for rendering user interfaces including login screens, home screens, and message screens.

The term “message information” refers to data representing a communication from one user to another, including a message body, sender and recipient identifiers, timestamps, and any associated metadata.

The term “destination user” refers to a user designated as the recipient of message information transmitted from another user through the system.

The term “user-related information” refers to information associated with a particular user, including message information, user information, profile information, skill information, interest information, and past message usage history information.

The term “prompt sentence” refers to a text string or sequence of tokens generated by the processor and supplied as input to a generative AI model, the text string specifying instructions, context, and constraints for generating advice information or message candidate information.

The term “generative AI model” refers to a machine-learned model, such as a neural network-based text generation model, configured to accept textual input including a prompt sentence and to output generated text such as advice information and message candidate information.

The term “personal branding” refers to the representation and communication of a user's characteristics, values, skills, and experiences to other users or audiences in a consistent and purposeful manner.

The term “personal-branding advice information” refers to generated text that provides guidance, recommendations, or explanations for how a user should describe or present themselves to strengthen their personal brand.

The term “message candidate information” refers to one or more generated text proposals for messages that the user may send, each proposal reflecting the user-related information and personal-branding policy.

The term “message creation screen” refers to a user interface presented on the communication terminal that allows the user to view AI-generated content, edit text, and compose final message information.

The term “final message information” refers to message information that has been confirmed by the user after optionally editing message candidate information and that is ready to be stored and delivered to a destination user.

The term “delivery processing” refers to operations executed by the processor to route, queue, and transmit message information from a sending user to a destination user, including updating storage device records and communicating with communication terminals.

The term “connection management information” refers to data maintained by the processor representing the connection state of users, including information about whether a communication terminal associated with a user is online or offline.

The term “online state” refers to a condition in which a communication terminal is currently connected to the server through a communication channel that allows the server to immediately transmit message information to the terminal.

The term “offline state” refers to a condition in which a communication terminal is not currently connected to the server, such that message information cannot be immediately transmitted to the terminal.

The term “real-time communication method” refers to a communication protocol or technique, such as persistent connection-based messaging, that enables the server to push message information to a communication terminal with low latency during an online state.

The term “undelivered information” refers to message information that has been stored in the storage device but has not yet been transmitted to or acknowledged by the destination user's communication terminal.

The term “history information” refers to recorded data in the storage device that associates prompt sentences and outputs from the generative AI model with user identification information, time information, and conversation identification information.

The term “user identification information” refers to data that uniquely or persistently identifies a user within the system, such as a user ID or account identifier.

The term “time information” refers to data indicating the time at which events occur, such as timestamps associated with message transmission, AI requests, or AI responses.

The term “conversation identification information” refers to data used to group related messages and AI interactions into a single conversation or session, such as a conversation ID.

The term “analysis processing” refers to operations executed by the processor to examine history information, determine patterns or effectiveness of prompt sentences and AI outputs, and update configuration or logic for generating prompt sentences.

The term “profile information” refers to information describing a user's background, such as biography, professional history, or personal summary, stored in the storage device.

The term “skill information” refers to information describing abilities or competencies of a user, such as technical skills, professional skills, or other capabilities.

The term “interest information” refers to information describing topics, fields, or activities that a user prefers or follows.

The term “past message usage history information” refers to records of prior message transmissions, receptions, edits, and AI-assisted operations associated with a user.

The term “context information” refers to information generated by integrating multiple items of user-related information, including profile information, skill information, interest information, and past message usage history information, and used as part of a prompt sentence for the generative AI model.

The term “personal-branding policy” refers to a set of preferences, rules, or inferred characteristics that define how a particular user's personal branding should be expressed in generated messages.

The term “emotion analysis algorithm” refers to a computational method that analyzes text or other input to identify an emotional state, such as positivity, negativity, or specific feelings expressed by a user.

The term “emotional state” refers to a representation of the user's affective condition, inferred by the emotion analysis algorithm based on the content and style of the user's message information.

The term “expression” refers to linguistic content, such as words, phrases, or sentences, included in message information and used by the emotion analysis algorithm to determine the emotional state.

The term “conversation” refers to a sequence of related message information instances and associated AI interactions exchanged between two or more users over time.

The term “AI-interaction logging” refers to the process of recording, in the storage device, data related to each interaction with the generative AI model, including prompt sentences, AI outputs, and linked metadata.

In one embodiment, a server, a terminal, and a user cooperate to implement a messaging and personal-branding support system that integrates a generative AI model with message routing, user context management, and connection-state control.

The server includes a processor, a main memory, and a non-transitory storage device, such as a magnetic disk drive or a solid-state drive. The server is connected to a communication network, such as the Internet, via a network interface. The server executes server-side software, for example an application implemented on a generic web framework, an operating system, a database management system, and an AI client library. The storage device stores user records, message records, connection-management records, and AI-interaction history records in structured data formats, such as relational tables or document-oriented collections.

The terminal includes a processor, a memory, a display unit, an input unit, and a communication interface. The terminal executes a communication application, for example a native mobile application or a web application running in a browser, and exchanges data with the server via a secure communication protocol. The terminal displays user interfaces for login, home view, and message creation, captures user input, and renders AI-generated content.

The user operates the terminal to access the communication application, authenticate to the server, compose messages, and optionally request assistance from a generative AI model for personal branding. The user provides profile information, skills, interests, and draft messages through the user interface.

The server uses a database management system, such as a relational database or a document database, to store user information, profile information, message information, and AI-interaction history information. The server stores user information in a user table or collection including fields such as a user identifier, an authentication credential, a profile summary, a skill list, and an interest list. The server stores message information in a message table or collection including fields such as a message identifier, a sender identifier, a destination identifier, a message body, timestamps, an AI-assisted flag, and a delivery status. The server stores connection-management information in a memory-resident map, such as a key-value structure, associating a user identifier with an online or offline state and an active connection channel. The server stores AI-interaction history information in an AI history table or collection including fields such as a user identifier, a conversation identifier, a prompt sentence, an AI-generated output, a timestamp, and an acceptance indicator.

The server executes a generative AI client module that communicates with a generative AI model implemented as a trained neural network, such as a transformer-based language model. In one embodiment, the generative AI model comprises an input embedding layer, a plurality of transformer blocks, and an output projection layer. Each transformer block includes a multi-head self-attention sub-layer, a feed-forward sub-layer, and normalization sub-layers. The generative AI model receives tokenized text input representing a prompt sentence and user-related context and produces a sequence of output tokens representing advice information and message candidate information. The generative AI model uses a learned parameter set, such as weight matrices and bias vectors, obtained by supervised or semi-supervised training on a large corpus of text data. The training process can use a loss function such as cross-entropy between predicted tokens and ground-truth tokens, and an optimization algorithm such as stochastic gradient descent or Adam. During training, the model updates the weights using backpropagation and gradient-based optimization, and optionally applies data augmentation, regularization, or dropout to improve generalization.

The server generates a prompt sentence by combining multiple pieces of user-related information into a single, structured input for the generative AI model. The server uses a prompt-construction algorithm that assembles a text segment specifying a role instruction, a text segment encoding user profile information, a text segment encoding skill and interest information, a text segment encoding past message usage patterns, and a text segment encoding an emotional state derived from the user's current message. The server arranges these text segments in a predetermined order and inserts boundary markers or meta-instructions so that the generative AI model can distinguish between context and instructions. By standardizing this structure, the server improves the consistency of the model's behavior and reduces the need for repeated parsing of user data at the model level.

The server performs emotion analysis by applying an emotion analysis algorithm to the text of a user's draft message. In one embodiment, the server uses a separate neural network classifier, such as a recurrent neural network or a smaller transformer, that has been trained to output an emotion label or emotion scores for categories such as “confident,” “anxious,” or “neutral.” The emotion analysis model can use word embeddings, sentence embeddings, or character-level features as input, and can be trained with a loss function such as cross-entropy over discrete emotion classes. The server converts the output of the emotion analysis algorithm into a text description of the emotional state, which is then embedded into the prompt sentence, for example by a phrase such as “The user currently sounds anxious about presenting their strengths.”

The server maintains connection-management information in an in-memory data structure. For example, the server can use a hash map where the key is a user identifier and the value is a structure containing a connection state flag and a reference to a persistent communication channel such as a WebSocket. When the terminal establishes a real-time communication channel with the server, the server updates the connection-management information to indicate that the associated user is in an online state. When the terminal disconnects, the server updates the information to indicate an offline state. This structure allows the server to rapidly determine the delivery route for each outgoing message without performing expensive database lookups.

The terminal retrieves user profile information and message history from the server and displays them to the user. The terminal may cache a subset of this information in a local storage area to reduce network requests. When the user opens a message composition screen, the terminal displays a text input area and an option to request AI-based assistance. The terminal captures each character entered by the user and updates the draft message in memory.

The user may, for example, enter the following free-form text at the terminal:
“I am a freelance web designer with 5 years of experience in e-commerce sites, but I don't know how to present my strengths to potential clients.”

The terminal transmits this draft text and a request for AI assistance to the server. The server retrieves the corresponding user-related information from the storage device, including profile information indicating that the user is a designer, skill information listing design tools and programming languages, interest information listing preferred industries, and past message usage history information indicating the user's typical tone. The server then constructs a prompt sentence such as:
“You are a branding assistant. Analyze the following user description and rewrite it as a clear, compelling personal brand statement suitable for a messaging application. Focus on concrete strengths and the value to clients. User description: ‘I am a freelance web designer with 5 years of experience in e-commerce sites, but I don't know how to present my strengths to potential clients.’”

In another example, the server constructs a prompt sentence for a different use case such as: “Explain how the user can express their personal brand effectively through a messenger application. Provide three message examples tailored to a software engineer who wants to highlight their problem-solving skills.”

The server tokenizes the prompt sentence and context information into tokens according to the vocabulary of the generative AI model, and transmits the token sequence, or a text representation that will be tokenized by an external AI service, through a secure channel. The generative AI model processes the input tokens using the attention mechanism in the transformer blocks, whereby each token representation attends to other tokens with attention weights derived from learned query, key, and value matrices. The model computes intermediate hidden states through multiple layers and finally generates an output token sequence representing recommended branding phrases, message drafts, or structured advice.

The server receives the output tokens from the generative AI model and decodes them into text. The server then stores the prompt sentence and the generated output in the AI-interaction history structure together with the user identifier, conversation identifier, and timestamp. By storing this association, the server enables later analysis of which prompt patterns and context combinations yield effective results. The server can later execute an analysis routine that groups AI interactions by user, by emotional state, or by acceptance rate, and updates internal prompt-construction templates. For example, the server can increase the emphasis on concrete achievements or client benefits in prompt sentences for users whose history indicates that such focus yields higher acceptance of AI suggestions.

The terminal receives the AI-generated output text from the server, parses the structure, and displays the advice information and message candidate information to the user within the message creation screen. The terminal can, for instance, show a section labeled “Suggested message” with a complete text that the user can send immediately, and separate sections labeled “Key strengths” or “Tone suggestions” that the user may incorporate manually. The user can edit the suggested message directly in the text input field, preserving or discarding parts of the AI-generated text.

The server uses the final message information confirmed by the user as the basis for message delivery. The server writes a new record to the message storage structure, setting the delivery status flag to a pending or queued state. The server checks the connection-management information to determine whether the destination user is currently online. If the destination user is online, the server pushes the message to the destination terminal through the real-time communication channel. If the destination user is offline, the server stores the message as undelivered information in the storage device, and marks it to be delivered upon the next successful authentication of the destination user. This integration of message routing and AI support at the server reduces the need for the terminal to implement complex orchestration logic and minimizes redundant network traffic.

The terminal of the destination user receives the delivered message and renders it in a conversation view. The user can see that the sender's message has been refined through AI suggestions that draw on their personal branding context. The destination user can then reply, optionally requesting AI assistance to construct a response that emphasizes their own brand or emotional perspective. The server processes this reply in the same manner, thereby providing symmetrical support for both parties in the conversation.

From a technical perspective, the server's integration of user context, emotion analysis, prompt construction, AI interaction, and message routing yields several improvements over conventional systems. The server reduces computational overhead by maintaining user-related context information in structured data formats and reusing it across multiple AI interactions without re-parsing raw user input every time. The server improves latency by maintaining connection-management information in memory rather than querying a persistent storage for each message, enabling faster determination of delivery routes. The server improves the relevance and stability of AI outputs by constructing standardized prompt sentences that encode detailed, machine-readable context, including emotional state and past message history, allowing the generative AI model to condition its output more precisely.

The server's history-based optimization further enhances system performance. By logging prompt sentences, AI outputs, and acceptance indicators in a unified structure, the server can perform offline or online analysis to adjust prompt templates and model usage policies. For example, the server can automatically reduce the length of prompts that are empirically associated with latency spikes without loss of quality, or it can adjust the weighting of emotion descriptors in prompts to reduce misalignment with user tone. This feedback loop constitutes an improvement in the way the computer system manages and applies generative models, rather than merely automating human drafting.

In another embodiment, the server can run an internal fine-tuning component for the generative AI model using user-approved messages as training data. The server can periodically select AI-interaction records where the user accepted or minimally edited the generated output and use these records as additional training examples. The server can construct a fine-tuning dataset where the input consists of context-rich prompt sentences and the target output consists of accepted message texts. The server can then perform gradient updates on a copy of the base model using an objective such as minimizing cross-entropy loss between the model's predictions and the accepted outputs. In this way, the model gradually adapts to the style and structure that lead to high acceptance on this particular messaging platform, further improving accuracy and reducing editing effort.

In some implementations, the terminal can perform part of the emotion analysis or prompt structuring locally to reduce server load or network latency. For example, the terminal can run a lightweight emotion classifier on the draft message and append an emotion descriptor such as “The user feels uncertain” to a prompt template before sending it to the server. The server, in turn, can use this emotion descriptor as an additional feature when constructing the final prompt sentence. This division of labor can further decrease end-to-end response time while still allowing the server to maintain centralized history and optimization logic.

The described architecture is not limited to a specific physical deployment. The server can be implemented as a cluster of computing nodes behind a load balancer, with individual nodes handling authentication, message routing, AI interaction, or logging. The storage device can be distributed across multiple physical units or cloud storage services. The generative AI model can be hosted on dedicated accelerator hardware, such as graphics processing units or tensor processing units, to improve throughput and reduce inference time. The system can also employ caching mechanisms for frequent prompt patterns or partial model outputs to further improve performance.

By designing the server to orchestrate generative AI interactions through structured prompt sentences that integrate user profile information, skill information, interest information, past message usage history information, and emotional state information, and by tightly coupling this orchestration with real-time message routing and connection-state management, the system achieves technical effects such as reduced processing redundancy, lower latency, improved output relevance, and enhanced scalability. These effects arise from specific data structures, control flows, and model-integration mechanisms implemented at the computer-system level, and are not merely the automation of human editorial tasks.

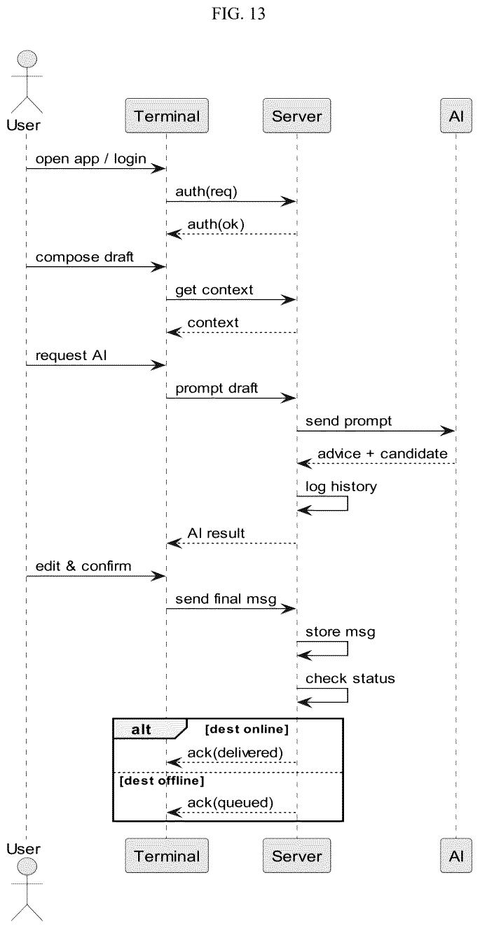

The following describes the processing flow using FIG. 13.

### Step 1:

The user launches the communication application on the terminal and requests login. The terminal displays a login screen and receives authentication information (input: user identifier and password) from the user through an input interface. The terminal performs local format checks, then packages the authentication information into a structured request and sends it to the server via a secure communication channel (output: login request data sent to the server).

### Step 2:

The server receives the login request and performs authentication processing. The server parses the request (input: user identifier and password), computes a hash of the password, and executes a database query against the storage device to compare the hash with stored credentials. The server determines whether the authentication succeeds and, if successful, retrieves user information such as profile information and basic settings. The server generates screen display data and a session token (output: authentication result, session token, and initial user information) and returns them to the terminal.

### Step 3:

The terminal receives the authentication response and initializes the home screen. The terminal uses the authentication result and session token (input: session token and initial user information) to store the token in a secure local area and to construct the user interface representing recent conversations and options such as “New message” and “AI assistance.”

The terminal renders the home screen and waits for further user operations (output: displayed home screen and active authenticated session).

### Step 4:

The user selects a message composition function on the terminal. The terminal detects the user operation (input: user action on the home screen) and opens a message creation screen. The terminal initializes an empty draft message structure and a recipient field, and it displays text input controls and an “Use AI for personal branding” option (output: message creation screen with empty draft and controls).

### Step 5:

The user enters a draft message and selects a destination user. The terminal captures keystrokes and selection events (input: free-form text, recipient selection) and updates the draft message object and recipient identifier in memory. The terminal may locally count characters or words, and it stores the current state of the draft (output: updated draft message, selected recipient, ready for AI assistance request).

### Step 6:

The user requests AI-based assistance for personal branding. The terminal detects the user's request (input: user action such as tapping an “Use AI” button) and sends a context request to the server including the user identifier and possibly a summary of the draft. The server receives this request, retrieves user-related information from the storage device (input: user identifier), including profile information, skill information, interest information, and past message usage history information, and returns these data to the terminal (output: user-related context information for prompt construction).

### Step 7:

The terminal constructs a prompt sentence for the generative AI model. The terminal receives user-related context and the current draft message (input: profile information, skills, interests, past usage history, and draft text) and executes a prompt-construction routine. The terminal concatenates a role instruction segment, a context description segment, and the draft message segment into a structured prompt sentence. For example, the terminal may create a prompt sentence such as:
“You are a branding assistant. Analyze the following user description and rewrite it as a clear, compelling personal brand statement suitable for a messaging application. Focus on concrete strengths and the value to clients. User description: ‘I am a freelance web designer with 5 years of experience in e-commerce sites, but I don't know how to present my strengths to potential clients.’”

The terminal stores the resulting prompt sentence (output: generated prompt sentence to be sent to the server or to the generative AI model).

### Step 8:

The server optionally performs emotion analysis on the draft message and enriches the prompt sentence. The terminal sends the draft message and initial prompt structure to the server (input: draft text and base prompt template). The server applies an emotion analysis algorithm to the draft text, computing scores for emotion categories and selecting a dominant emotional state. The server converts the emotional state into a textual descriptor and inserts it into the prompt sentence, for example: “The user currently sounds anxious about presenting their strengths.” The server outputs an enhanced prompt sentence (output: context-and emotion-enriched prompt sentence for the generative AI model).

### Step 9:

The server interacts with the generative AI model using the prompt sentence. The server tokenizes the enriched prompt sentence (input: enriched prompt sentence) into tokens according to the vocabulary of the generative AI model and transmits the token sequence or text to the generative AI model endpoint. The generative AI model processes the prompt sentence through its neural architecture, performing vector transformations and attention-weight computations to generate output tokens. The server receives the output token sequence, decodes it into text, and obtains personal-branding advice information and message candidate information (output: AI-generated advice text and message candidate text).

### Step 10:

The server stores AI-interaction history information. The server associates the prompt sentence and the AI-generated output (input: prompt sentence, advice information, message candidate information, user identifier, and conversation identifier) and writes a record into an AI history structure in the storage device. The server records metadata such as timestamps and acceptance flags initialized to a default value. This write operation (output: persistent AI-interaction history record) supports later analysis for prompt optimization.

### Step 11:

The server sends the AI-generated content to the terminal. The server packages the advice information, message candidate information, and any structural hints (input: AI output text and metadata) into a response message and transmits it to the terminal. The output of this step is structured AI content ready to be displayed on the message creation screen (output: AI-enhanced content response to the terminal).

### Step 12:

The terminal displays the AI-generated advice and message candidate information to the user. The terminal receives the AI-enhanced content (input: advice information and message candidate information) and parses it into sections such as “Suggested message,” “Key strengths,” or “Recommended tone.” The terminal updates the message creation screen to show the AI-generated text and provides editing controls that allow the user to insert, delete, or modify the proposed message parts (output: updated UI displaying AI suggestions and an editable message field).

### Step 13:

The user edits and confirms the final message information. The user reads the AI-generated content (input: displayed advice and suggested message), adjusts the text to reflect personal preferences, and finalizes a message through confirmation input. The terminal captures the edits and confirmation action and composes a final message structure containing the finalized message body and the recipient identifier (output: confirmed final message information and destination user identifier).

### Step 14:

The terminal transmits the final message information to the server for delivery. The terminal constructs a delivery request (input: final message text, recipient identifier, session token, and AI-assisted flag) and sends it to the server using a secure communication protocol. The terminal may also locally log the message for conversation continuity (output: delivery request containing final message information submitted to the server).

### Step 15:

The server stores the final message information and prepares it for routing. The server receives the delivery request (input: final message information and destination identifier), validates the session token, and writes a record into the message storage structure. The server sets fields such as sender identifier, destination identifier, message body, creation timestamp, AI-assisted flag, and an initial delivery status value indicating pending or queued. The server outputs a stored message record ready for delivery (output: persistent message record with routing metadata).

### Step 16:

The server determines the connection state of the destination user and performs delivery processing. The server accesses the connection-management information (input: destination user identifier and connection state record) to determine whether the destination user is online or offline. If the destination user is online, the server retrieves the corresponding communication channel reference and pushes the message content to the destination terminal, updating the message status to delivered. If the destination user is offline, the server maintains the message status as undelivered and stores it as undelivered information in the storage device. The server also schedules the message for delivery upon the next successful login of the destination user (output: message delivered to the destination terminal or queued for later delivery).

### Step 17:

The terminal of the sender receives acknowledgment of delivery status. The server sends a status response (input: updated delivery status) to the sender's terminal, indicating that the message has been accepted for routing and whether it has been delivered or queued. The terminal updates the conversation view to reflect the new status icon or label for the sent message (output: updated sender-side display with delivery status information).

### Step 18:

The terminal of the destination user receives and displays the delivered message. When the destination user is online and the server pushes a message (input: delivered message data), the terminal writes the message to its local conversation cache and updates the conversation user interface to show the newly received text. The terminal may also generate a notification or highlight the conversation in a list view (output: message visible in the destination user's conversation view).

### Step 19:

The user at the destination terminal reads the received message and optionally requests AI assistance to generate a reply. The destination user opens the message thread (input: displayed message) and decides to respond. The terminal captures the draft reply and, if the user requests AI support, sends the draft and related context back to the server for prompt sentence construction, emotion analysis, and generative AI interaction as described in previous steps. The output is a new prompt sentence and a new cycle of AI-assisted message generation for the reply.

### Step 20:

The server performs history-based optimization for future prompt sentences. At arbitrary times or upon specific triggers, the server processes the AI-interaction history (input: stored prompt sentences, AI outputs, user acceptance indicators, and associated metadata) using an analysis algorithm. The server identifies patterns such as which prompt structures yield higher acceptance or shorter editing times. Based on this analysis, the server updates internal prompt-construction rules, such as modifying the order of context segments, emphasizing certain user attributes, or adjusting emotional descriptors. The output of this step is an updated set of prompt-generation parameters that the server will use in subsequent AI interactions to improve system performance and personalization.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented branding support systems typically treat user profile data, user messages, and generative artificial intelligence outputs as loosely coupled components. In many such systems, user information is collected once, a fixed prompt is crafted manually or according to simple templates, and a generative AI model is invoked to return advice or content. The returned output is then displayed to the user without systematic integration of real-time emotional state, contextual information from user devices, or feedback history. As a result, these systems exhibit several technical limitations at the computing level.

First, traditional systems lack an integrated computation pipeline for dynamically constructing prompt sentences based on heterogeneous, time-varying data sources. User attributes, skills, activity history, physical-space context (such as store location and item identification), and emotional state are typically processed separately, if at all. This leads to prompts that are either generic or only weakly personalized, reducing the effectiveness and efficiency of the generative AI model, and causing redundant or repetitive processing on the server side.

Second, many existing architectures do not perform fine-grained emotion analysis as a first-class control signal within the server's control logic. Emotion analysis (if present) is often applied as a cosmetic overlay at the user interface layer, rather than being used to modify how the server constructs prompts, schedules model calls, or adjusts generated content. In such architectures, the processor does not fully exploit emotion analysis results to modify internal data flows, to prioritize or filter content, or to automatically reconfigure the generative AI interaction, which limits the adaptability of the system and can lead to unnecessary generative AI calls and increased computational load.

Third, conventional systems do not maintain a persistent, machine-usable representation of user feedback that is reinjected into the prompt-construction logic. Feedback such as “helpful” or “not relevant” is often stored only for analytics, without being used by the processor to update prompt construction policies or data preprocessing strategies. Without a closed feedback loop, the computing system cannot progressively refine the parameterization and structure of prompt sentences or adjust its preprocessing pipeline, resulting in repeated generation of suboptimal advice and inefficient use of computing resources and network bandwidth.

Fourth, in many systems that operate in a physical environment such as a retail store, contextual information from user terminals such as location, proximity to items, and sensor readings is underutilized in the server's generative AI workflow. The processor typically handles such context for basic lookup operations, but does not tightly integrate this context with the user's evolving skill data and emotional state to construct more precise prompts. Consequently, the system cannot efficiently narrow the query space of the generative AI model, and may generate irrelevant or overly broad content, which increases processing time and resource consumption.

Fifth, existing systems often lack a coherent mechanism by which updates to user skills or experiences trigger automatic recomputation of personal branding strategies within the server. Changes in profile data are stored, but they do not systematically cause the processor to regenerate prompts, re-query the generative AI model, and update strategy data structures. This absence of event-driven reconfiguration of the generative AI workflow leads to stale strategy data and inefficiencies in reusing or updating previous computation results.

Accordingly, there is a need for a computer-implemented system and server architecture that tightly integrates: (i) acquisition and preprocessing of user data and context data; (ii) dynamic, stateful construction of prompt sentences for a generative AI model; (iii) emotion analysis as a control signal for adjusting prompts and outputs; (iv) event-driven recomputation of strategies upon profile updates; and (v) a feedback-driven mechanism for updating prompt construction policies. Such a system should improve the way a processor organizes, sequences, and optimizes calls to a generative AI model and associated analysis modules, thereby improving the overall operation of the computer system, including latency, relevance of generated outputs, and efficiency in processing heterogeneous user data streams.

The specific processing by the specific processing unit 290 of the data processing device 12 in Application Example 2 is realized by the following means.

The present invention provides a server comprising a processor and a memory storing instructions which, when executed by the processor, cause the processor to acquire and preprocess user information from one or more user terminals, dynamically construct a prompt sentence for input to a generative AI model based on the preprocessed user information and context information including at least one of textual input, sensor input, and location input, input the prompt sentence into the generative AI model to cause the generative AI model to generate guidance information or content information for supporting formation of a personal brand of a user, apply an emotion analysis algorithm to at least one of text information, voice information, and image information obtained from the user terminals to identify an emotional state of the user, adjust at least one of a content of the prompt sentence, the guidance information, and the content information in accordance with the identified emotional state and the user information, provide the guidance information or the content information to the user terminals for message-based interaction with the user, and update a construction policy for subsequent prompt sentences based on feedback information received from the user terminals. This enables the computing system to internally orchestrate data acquisition, emotion-aware prompt construction, generative AI invocation, and adaptive content delivery in a closed feedback loop, thereby improving the technical performance of the server in terms of responsiveness, relevance of generated outputs, and efficient utilization of processing and communication resources.

The term “user information” refers to machine-readable data associated with a user, including at least attribute data, skill data, interest data, activity-history data, and optionally physical-space position data and item-identification data, which are received and processed by the system.

The term “context information” refers to information that represents a situational state of a user or a user terminal, including at least one of textual input, sensor input, and location input, and which is used by the processor to adapt prompt construction and output generation.

The term “prompt sentence” refers to a machine-generated or machine-modified textual instruction that is provided as input to a generative AI model to specify a task, constrain a response, or request particular guidance or content.

The term “generative AI model” refers to a computer-implemented artificial intelligence model configured to generate natural-language or other content in response to a prompt sentence, based on parameters learned from training data.

The term “guidance information” refers to generated machine-readable content that includes recommendations, strategies, or instructions for supporting formation or adjustment of a user's personal brand.

The term “content information” refers to generated machine-readable content other than guidance information, including at least brand-story information, background information, example phrases, or suggested media items, which are presented to the user.

The term “personal brand” refers to a representation of a user's perceived strengths, values, skills, and characteristics as expressed toward other parties through communication or presentation.

The term “emotion analysis algorithm” refers to a computational procedure that receives text, voice, image, or other data as input and outputs an identified emotional state or sentiment label associated with a user.

The term “emotional state” refers to a machine-interpretable representation of a user's affective condition, including at least one of categories such as positive, negative, neutral, joy, sadness, fatigue, or excitement, optionally with an associated intensity.

The term “user terminal” refers to an electronic device operated by a user, including at least a portable communication device, a head-mounted display device, or a computing device, configured to acquire user input, present information, and communicate with the server.

The term “message-based interaction” refers to a communication mode in which information is exchanged between the server and a user via discrete messages, such as text messages, chat messages, or similar conversational units, over a communication network.

The term “feedback information” refers to information provided from a user terminal to the server indicating a user's evaluation, preference, or reaction to generated guidance information or content information, including at least explicit ratings or textual comments.

The term “construction policy” refers to a set of rules, parameters, or learned models that govern how the processor selects, orders, and combines elements of user information and context information to build a prompt sentence for the generative AI model.

The term “attribute information” refers to user information describing static or slowly changing characteristics of a user, including at least demographic data, occupational data, or role-related data.

The term “skill information” refers to user information indicating capabilities, competencies, or qualifications of a user, such as areas of expertise, acquired skills, or certifications.

The term “interest information” refers to user information indicating topics, domains, or activities that a user prefers or is inclined toward, as inferred from explicit input or behavioral data.

The term “activity history information” refers to user information indicating past actions or interactions of a user within the system or related environments, such as prior messages, viewed items, or accepted recommendations.

The term “physical-space position information” refers to data representing a position of a user or a user terminal in a real-world environment, obtained from at least one of location sensors, wireless beacons, or identification tags.

The term “item identification information” refers to data that uniquely or semi-uniquely identifies a physical or digital item, such as a product identifier, service identifier, barcode, or tag identifier.

The term “brand story information” refers to generated content describing narrative aspects of a product, service, organization, or user, including history, values, or motivations associated with the brand.

The term “background information” refers to generated explanatory content related to a product, service, or user, including at least manufacturing details, usage context, or supporting facts that supplement a brand story.

The term “personal branding strategy information” refers to structured or semi-structured guidance information that specifies recommended actions, messaging, positioning, or content themes for developing or modifying a personal brand.

In one embodiment, a server, one or more terminals, and one or more users cooperate to implement the claimed system. The server comprises at least one processor, a memory, and one or more network interfaces. The terminal comprises at least one processor, a display, an input unit, and optionally one or more sensors such as a camera, a microphone, and a location sensor. The user operates the terminal to provide information and to receive guidance and content generated by the system.

The server executes programs stored in the memory to implement functional modules including a data acquisition module, a preprocessing module, a context management module, a prompt-construction module, a generative-AI interface module, an emotion-analysis module, a policy-update module, and a delivery module. The server executes these modules using general-purpose software components such as an operating system, a web server framework, a database management system, and machine learning libraries. For example, the server uses a web framework such as a generic HTTP application framework to receive HTTP or HTTPS requests, uses a data analysis library such as a table-oriented processing library to manipulate tabular user data, uses a database system such as a relational or document-oriented database to store user records, uses a natural language processing library such as a tokenization and parsing engine to process text, and uses a machine learning framework such as a tensor-based computation engine to implement an emotion-analysis model and to interface with a generative AI model.

The terminal runs an application that provides a user interface for entering user information and for viewing generated guidance and content. In one implementation, the terminal is a smartphone executing a mobile operating system, and the application is developed using a standard mobile application development environment. In another implementation, the terminal is a head-mounted display device that provides a see-through display for in-store staff. The terminal application communicates with the server through a network using standard protocols such as HTTPS or WebSocket.

The server acquires user information from the terminal in the form of structured and unstructured data. The terminal sends profile information such as attribute information, skill information, interest information, and activity history information as structured fields in a request body, and sends free-form text messages, images, and audio clips as additional payloads or references. The server stores the structured data in normalized tables or collections and associates the unstructured data with identifiers for later processing. For example, the server stores user skills as rows in a skill table with columns for user identifier, skill name, proficiency level, and last update time; the server stores user messages in a message table with columns for user identifier, timestamp, message text, and optional media references.

The server preprocesses the user information before using it to construct a prompt sentence. The server uses the natural language processing library to tokenize message text, perform part-of-speech tagging, lemmatization, and named entity recognition, and to extract domain-specific terms such as skill names and interest topics. The server converts unstructured text into feature vectors by mapping tokens to embedding vectors obtained from a word- or sentence-embedding model. The server constructs intermediate data structures such as feature objects containing fields for extracted skills, topics, sentiment cues, and contextual tags. Because the server maintains these feature objects in memory and in the database, the server can reuse them across multiple interactions, reducing redundant computation and improving response time.

The server manages context information that includes terminal sensor data and physical-space information. The terminal acquires location information using positioning hardware such as a satellite-based receiver, short-range wireless beacons, or network-based positioning. The terminal may also read product identifiers using input means such as a barcode scanner, a near-field communication reader, or a camera-based recognition module. The terminal sends location coordinates and item-identification information to the server as part of the user request. The server maps location coordinates or item identifiers to store zones and product records in a context table. In this way, the server maintains a context state that ties the user's current physical position and attention to specific items or zones. This context state is used during prompt construction to focus the generative AI model on a reduced, relevant subset of information, which reduces the size and complexity of prompts and, therefore, computational load.

The server constructs a prompt sentence by combining user information and context information according to a construction policy. The construction policy specifies how to select and order textual segments that represent user attributes, skills, interests, emotional state, and physical context. The server implements the construction policy as a set of rules or as a learned model. For example, in a rule-based implementation, the server inserts required segments in the order: (1) description of the user's role and skills, (2) description of the current emotion, (3) description of the current physical context or focus item, and (4) explicit instruction about the desired type of output. The server uses templates with placeholders that are filled with specific values extracted from user and context data.

In one example, the server composes the following prompt sentence for a generative AI model:
“The user has newly acquired the skill ‘data science’ and wants to strengthen a personal brand as a consultant. Generate a detailed branding strategy.”

In another example, when the user is in a physical store and viewing a specific product, the server composes the following prompt sentence:
“The customer is looking at this product. Explain the brand story and production background in an emotionally engaging way.”

In yet another example, when the user's emotional state indicates fatigue, the server composes the following prompt sentence:
“The user is feeling tired after work. Propose relaxing actions and content that still reinforce the user's personal brand.”

The server sends the prompt sentence to a generative AI model through the generative-AI interface module. In one implementation, the generative AI model is a neural network-based language model of the transformer architecture. The model comprises multiple layers of self-attention blocks and feed-forward networks, each layer parameterized by weight matrices and bias vectors. The model has been pre-trained on large text corpora using a language modeling objective that minimizes a cross-entropy loss between predicted and actual next tokens. During deployment in the server, the model parameters are fixed or fine-tuned on domain-specific data. The server calls the model through an application programming interface, providing the prompt sentence as input token sequences, and specifying parameters such as maximum output length, sampling temperature, and top-k or top-p sampling thresholds.

The server receives the model's generated token sequence, decodes the tokens into natural-language text, and post-processes the output. The server may segment the output into headings, bullet points, and paragraphs, and may annotate the output with metadata such as relevance scores and confidence values. The server may also run a secondary classifier or rule-based filter to detect and remove content that violates predefined guidelines. By structuring and filtering the generative output, the server produces guidance information and content information that are more concise and targeted, reducing the volume of data transmitted to the terminal and improving clarity for the user.

The server performs emotion analysis using a dedicated emotion-analysis module that operates on text, audio, and image data. For text, the server uses a separate neural network model, such as a bidirectional recurrent network or a transformer-based classifier, trained to map input sentences to emotion labels. The model receives tokenized sequences, encodes them into feature vectors, and outputs probability distributions over emotion categories such as joy, sadness, anger, fear, and neutral. The server selects the category with the highest probability and may use the probability value as intensity. For audio, the server extracts acoustic features such as pitch, energy, and spectral coefficients and feeds them to a trained classifier. For image data, the server uses a convolutional neural network that receives face-region images and outputs emotion probabilities. The server aggregates the results across modalities using a weighted averaging or rule-based fusion mechanism to determine a final emotional state.

The server uses the emotional state not only to annotate content but also to control prompt construction and output adjustment. For example, when the emotional state changes from joy to sadness, the server modifies the construction policy to include explicit supportive language and to request empathetic advice. In such a case, the server may build a prompt sentence such as:
“The user previously felt joy but now feels sadness about their career. Generate supportive, constructive branding advice adapted to this emotional state.”

By integrating emotion analysis results into the control logic for prompts, the server alters its internal data paths and reduces the frequency of unproductive generative-AI calls. For instance, if the emotion analysis indicates that a user is not receptive (e.g., high fatigue), the server can postpone long strategy generation and instead request short, low-computation messages, thereby reducing processing time and resource usage.

The server maintains and updates a construction policy based on feedback information from the terminal. The terminal provides user feedback in the form of rating selections, button presses, or short responses such as “helpful,” “too long,” or “not relevant.” The server logs each feedback instance with identifiers for the corresponding prompt and generative output.

The server analyzes the feedback logs using statistical methods or reinforcement learning algorithms to adjust the weights or priorities assigned to different components of the prompt. For example, when the server detects that outputs generated from prompts emphasizing technical skills consistently receive higher ratings than those emphasizing generic traits, the server increases the weight of skill-related segments in future prompts. In some variants, the server maintains per-user policies so that different users receive prompts tailored to their individual preferences, thereby reducing trial-and-error and improving response quality.

The server also responds to updates in user skills and experiences. When the user adds a new skill on the terminal, the terminal sends an update request with the new skill information. The server writes the new skill to the skill table and flags the associated strategy records as stale.

The server schedules a recomputation task that constructs a new prompt sentence focused on strategy updating. For example, the server may generate:
“The user's new skills are: data science and public speaking. Propose an updated, more advanced personal branding strategy that combines these skills.”

The server sends this prompt sentence to the generative AI model, obtains updated personal branding strategy information, and stores it in a strategy table. The terminal then retrieves and displays the updated strategy to the user. Because the server triggers strategy recomputation in response to specific data changes and uses structured prompts that explicitly reference the updated fields, the server reduces unnecessary recomputation and ensures that stored strategies remain aligned with the latest user profile.

In an in-store implementation, the server and terminal cooperate to support staff and customers in a physical retail environment. A staff member wears a head-mounted terminal that captures images and audio of a customer and transmits them to the server. The server performs real-time emotion analysis on this data and combines it with context information such as the customer's location within the store and items being viewed. The server constructs a short prompt sentence, for example:
“The customer shows joy and curiosity while looking at sports shoes. Generate two sentences of sales advice and one upsell suggestion.”

The server sends the prompt sentence to the generative AI model and receives a compact response. The server then forwards the advice to the head-mounted terminal, which displays it as an overlay in the staff member's field of view. By limiting the output length and focusing on specific items, this configuration reduces latency and network bandwidth, enabling real-time use in a constrained hardware environment. The system thus improves the operation of the head-mounted device as a guidance tool by offloading complex language generation to the server while providing only minimal, relevant text to the device.

From a technical perspective, the described system improves computer functioning beyond mere automation of human tasks. The server uses a specific internal data flow: preprocessing user information into structured features, maintaining context states, computing emotion states using multi-modal models, constructing prompt sentences under a policy, invoking a generative AI model with those prompts, and updating policies based on feedback. This pipeline reduces redundant computations by caching feature representations, shortens prompts by focusing on relevant context, and decreases the number of ineffective generative-AI calls by using emotion-based and feedback-based control. As a result, the system reduces processing time and network usage compared to naive architectures that simply forward raw text to a generative model without such preprocessing and control.

Moreover, the use of a construction policy that is updated from feedback constitutes a non-conventional control mechanism for a generative AI model. Rather than simply altering superficial user interface elements, the system changes internal prompt-generation rules, which directly affects the sequence of tokens sent to the model and, therefore, the internal activations and computational path within the model. The server computes policy updates using methods such as gradient-free optimization or multi-armed bandit algorithms that adjust discrete choice probabilities over template segments. This leads to more efficient exploration of prompt configurations at the system level and to improved accuracy in aligning outputs with user needs.

In alternative embodiments, the server implements different types of generative AI models and emotion-analysis models. In one variant, the generative AI model is fine-tuned on domain-specific branding texts using supervised learning with a loss function that encourages alignment with reference strategies. In another variant, the emotion-analysis model is a lightweight neural network optimized for deployment on edge devices, so that some emotion analysis is performed on the terminal and only aggregated labels are transmitted. In a further variant, the construction policy is represented as a decision tree that selects prompt templates based on discrete features such as user segment, platform type, and historical engagement metrics.

In another embodiment, the terminal performs additional preprocessing to reduce communication loads. The terminal may apply simple compression, local keyword extraction, or media downsampling before sending data. By doing so, the terminal reduces the size of transmitted data and lowers the processing burden on the server, while still allowing the server to perform higher-level analysis and prompt construction. In yet another embodiment, the server distributes processing across multiple machines, with separate services for emotion analysis, prompt construction, and generative-AI invocation, and uses an internal message queue to orchestrate data flow. This modularization allows independent scaling and improves fault tolerance.

The user interacts with the system by entering information and responding to generated content. The user types free-form queries such as “Tell me the brand story of this product,” “How can I use my data science skills to build a strong personal brand?” or “How should I communicate my passion for this new project?” The terminal sends these queries to the server, which incorporates them into the prompt sentence or uses them directly as part of the prompt. The user then reads the generated guidance and may follow suggested steps, for example by updating their public profile or by choosing specific courses or projects. Although these human-level actions occur outside the computing system, the described pipeline ensures that the computer operations leading to the generated guidance are efficient, structured, and technically grounded.

By providing these implementation details, including specific data structures, model architectures, training approaches, and control policies, the described embodiments allow a person skilled in the art to implement the system and understand how the particular arrangement of modules and algorithms yields technical improvements in processing speed, output relevance, data management, and resource utilization, beyond a mere abstract idea of providing branding advice.

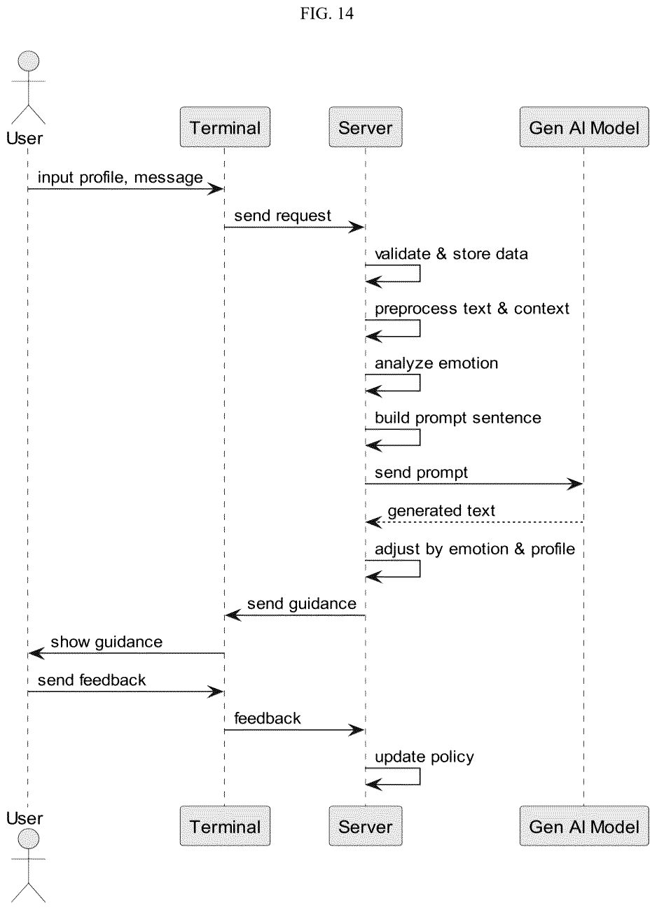

The following describes the processing flow using FIG. 14.

### Step 1:

The user operates the terminal to input profile information and context.

The user enters attribute information (for example, role, industry), skill information, interest information, and free-text messages into input fields of an application running on the terminal. The user optionally permits the terminal to access sensors such as a location sensor, a camera, and a microphone.

Input: raw user-keystroke text, selection values, and sensor readings.

The terminal converts these inputs into structured fields (for example, JSON key-value pairs for skills and attributes) and unstructured payloads (for example, raw text, image frames, audio samples). The terminal attaches metadata such as a timestamp and a user identifier.

Output: a request object containing structured user information, unstructured content, and metadata.

### Step 2:

The terminal transmits the request object to the server.

The terminal establishes an HTTPS connection to a server endpoint and sends the request object in the body of a POST request. The terminal may compress large media payloads or send references (for example, URLs) instead of full binary content.

Input: the request object generated in Step 1.

The terminal performs a serialization operation, encodes the data into a network-ready format, and forwards it to the server over a communication network.

Output: a network message delivered to the server.

### Step 3:

The server receives and validates the request object.

The server listens on a network interface, accepts the HTTPS request, and parses the received body into internal data structures using a parsing library. The server verifies mandatory fields such as user identifier and checks data types and maximum lengths for each field.

Input: serialized request object from the terminal.

The server performs syntactic validation (for example, JSON schema checking) and semantic validation (for example, existence of a registered user identifier). The server discards or flags invalid entries and passes valid user information to downstream modules.

Output: a validated user-information record and an associated unstructured-data bundle.

### Step 4:

The server stores and indexes the user information.

The server inserts or updates rows in a user profile data store, such as a relational database table or a document collection. The server writes attribute information, skill information, interest information, and activity history information into defined columns or fields.

Input: validated user-information record from Step 3.

The server executes database operations (insert, update, upsert) and constructs or updates indices on keys such as user identifier, skill names, and timestamps. These operations materialize the profile data for efficient retrieval.

Output: persistent records for the user profile and an update log entry.

### Step 5:

The server preprocesses user text messages.

The server retrieves the latest message text and relevant profile fields from the data store and passes them to a natural language processing module. The server tokenizes sentences, applies part-of-speech tagging, performs lemmatization, and extracts named entities and domain-specific terms.

Input: raw message text and profile text associated with the user.

The server converts the text sequences into token identifiers, computes embedding vectors, and generates feature lists such as extracted skills, topics, and key phrases.

Output: a feature object containing tokenized text, embeddings, and lists of extracted terms.

### Step 6:

The server acquires context information from sensor data.

The server reads context fields such as physical-space position information from the request metadata, and if item-identification information is present, the server looks up corresponding product or service records in a context database.

Input: location coordinates, beacon identifiers, or item-identification codes from the request object.

The server executes spatial queries or key-based lookups to map the raw context values to higher-level concepts such as store zone, shelf identifier, or product category.

Output: a context object describing the user's current physical environment and focus items.

### Step 7:

The server performs emotion analysis on multimodal inputs.

The server feeds the preprocessed text, and optionally audio and image data, to an emotion-analysis module. For text, the server uses a trained classifier model to compute probabilities over emotion categories. For audio, the server extracts acoustic features and applies a second classifier. For images, the server detects facial regions and uses a convolutional model to infer emotion.

Input: text embeddings and token sequences from Step 5, and media samples from the unstructured-data bundle.

The server calculates per-modality emotion scores and then aggregates them using a weighting rule or fusion algorithm, producing a single emotional state label with an associated intensity score.

Output: an emotional-state descriptor (for example, “joy, high intensity” or “fatigue, medium intensity”).

### Step 8:

The server constructs a prompt sentence for the generative AI model.

The server reads the feature object, the context object, and the emotional-state descriptor, and applies a construction policy to build a prompt sentence. The server selects template segments, fills placeholders with user attributes, skills, emotional state, and context, and orders them according to predefined rules.

Input: feature object from Step 5, context object from Step 6, emotional-state descriptor from Step 7, and stored construction policy parameters.

The server performs string concatenation, placeholder substitution, and optional length normalization to produce a single coherent textual instruction.

Output: a prompt sentence prepared for input to the generative AI model.

### Step 9:

The server invokes the generative AI model with the prompt sentence.

The server tokenizes the prompt sentence according to the vocabulary of the generative AI model and sends the token sequence to the model through an interface module. The server selects inference parameters such as maximum output tokens and sampling thresholds.

Input: prompt sentence from Step 8.

The server carries out the encoding, prepares an API request or an internal model call, and forwards the encoded prompt to the generative AI model for generation.

Output: a generated token sequence representing candidate guidance information or content information.

### Step 10:

The server decodes and post-processes the model output.

The server receives the generated tokens from the generative AI model and decodes them into natural-language text. The server may segment the text into sections (for example, title, bullet points, explanation) and detect structural markers such as headings or lists.

Input: generated token sequence from Step 9.

The server applies formatting rules, inserts line breaks, and optionally filters out undesired phrases using a rule-based checker. The server may also attach metadata tags for type (strategy, story, recommendation) and estimated relevance.

Output: structured guidance information or content information suitable for presentation.

### Step 11:

The server adjusts the output based on emotional state and user information.

The server revisits the emotional-state descriptor and user profile to decide whether further adjustments are needed. For example, the server shortens the text for a fatigued user or emphasizes positive reinforcement for a discouraged user.

Input: structured guidance or content from Step 10, emotional-state descriptor from Step 7, and user profile records from Step 4.

The server performs transformations such as trimming, paraphrasing sections via secondary templates, or reordering paragraphs to align tone and length with the emotional and profile context.

Output: an adjusted guidance or content package tailored to the user's current state.

### Step 12:

The server formats and sends the response to the terminal.

The server wraps the adjusted guidance or content into a response structure that includes text blocks, optional link placeholders, and minimal layout hints (for example, “display as chat message,” “display as card”).

Input: adjusted guidance or content package from Step 11.

The server serializes this structure into a response message and transmits it to the terminal over the established network connection.

Output: a response message containing user-tailored guidance and content.

### Step 13:

The terminal presents the generated guidance to the user.

The terminal receives the response message, parses the content, and maps it to user interface components such as chat bubbles, cards, or overlay text (for head-mounted devices).

Input: response message from Step 12.

The terminal executes UI rendering routines to draw text and interactive elements on the display, possibly with scrolling, tapping, or selection controls.

Output: a visual and/or audio presentation of the generated guidance to the user.

### Step 14:

The user evaluates the guidance and provides feedback.

The user reads or listens to the presented guidance and interacts with feedback controls such as buttons labeled “helpful,” “not relevant,” or “too long,” or enters a short comment in a text box.

Input: generated guidance displayed on the terminal and user's subjective evaluation.

The user performs selection or text entry operations, which the terminal records as feedback values associated with the displayed content.

Output: feedback data ready to be transmitted to the server.

### Step 15:

The terminal transmits feedback data to the server.

The terminal packages the feedback data together with identifiers of the corresponding prompt sentence and generated output and sends this package to the server using an HTTPS request.

Input: feedback values and associated identifiers from Step 14.

The terminal performs serialization and network transmission similar to Step 2, ensuring that the server can correlate each feedback instance with the original interaction.

Output: a feedback message delivered to the server.

### Step 16:

The server updates the construction policy based on feedback.

The server logs the received feedback together with prompt and output identifiers in a feedback table. The server runs an analysis procedure that tallies feedback statistics and updates policy parameters controlling prompt construction.

Input: feedback message from Step 15 and stored policy parameters from the policy store.

The server executes computations such as incrementing counts, computing moving averages of ratings per template segment, and adjusting weighting coefficients for different information types (for example, technical skills versus generic traits). These operations produce a new policy configuration.

Output: an updated construction policy that will influence future prompt sentences.

### Step 17:

The server reacts to updates in user skills or experiences.

When the user or terminal sends a subsequent request that includes new or modified skill or experience information, the server detects that these fields have changed compared to stored records.

Input: new user-information record from a later instance of Step 3 and prior profile records from Step 4.

The server performs a comparison operation to identify differences and flags relevant strategy entries as outdated. The server then builds a specialized prompt sentence to request a recomputed personal branding strategy, using the changed fields explicitly.

Output: a strategy-update prompt sentence ready for processing by the generative AI model.

### Step 18:

The server regenerates and delivers an updated personal branding strategy.

The server sends the strategy-update prompt sentence from Step 17 to the generative AI model and repeats the decoding and post-processing pipeline used in Steps 9 and 10. The server then adjusts the new strategy using the current emotional state and stores it as a new version in the strategy table.

Input: strategy-update prompt sentence from Step 17 and, optionally, an updated emotional-state descriptor from a new run of Step 7.

The server produces a refined strategy document and transmits it to the terminal using the same mechanisms as in Steps 11 and 12.

Output: an updated personal branding strategy presented to the user on the terminal.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

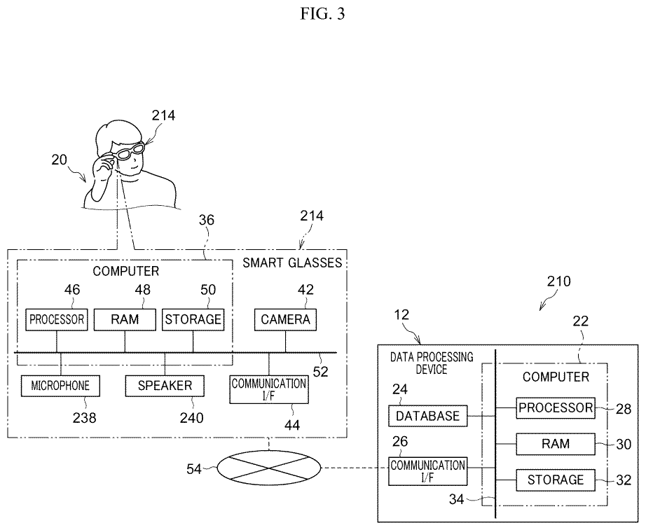

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

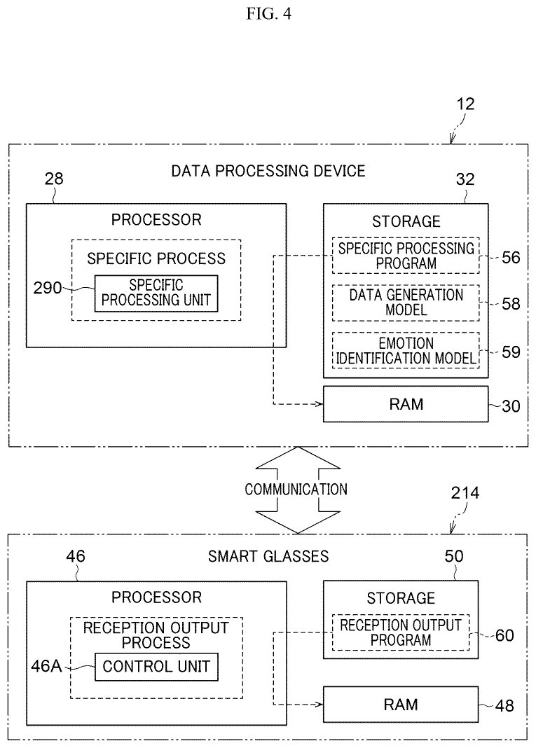

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

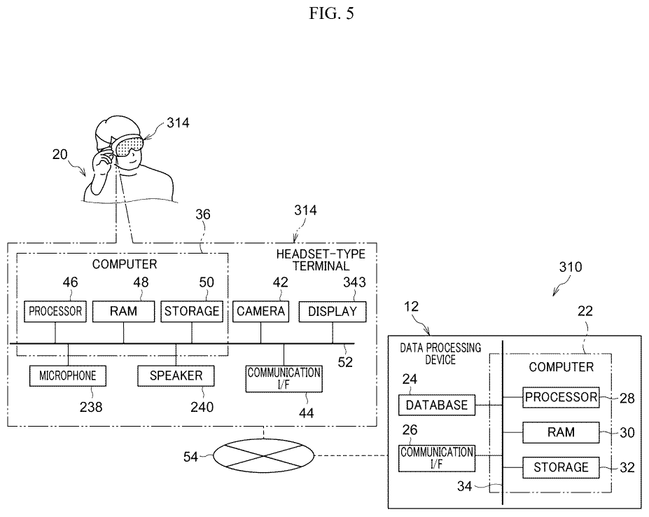

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

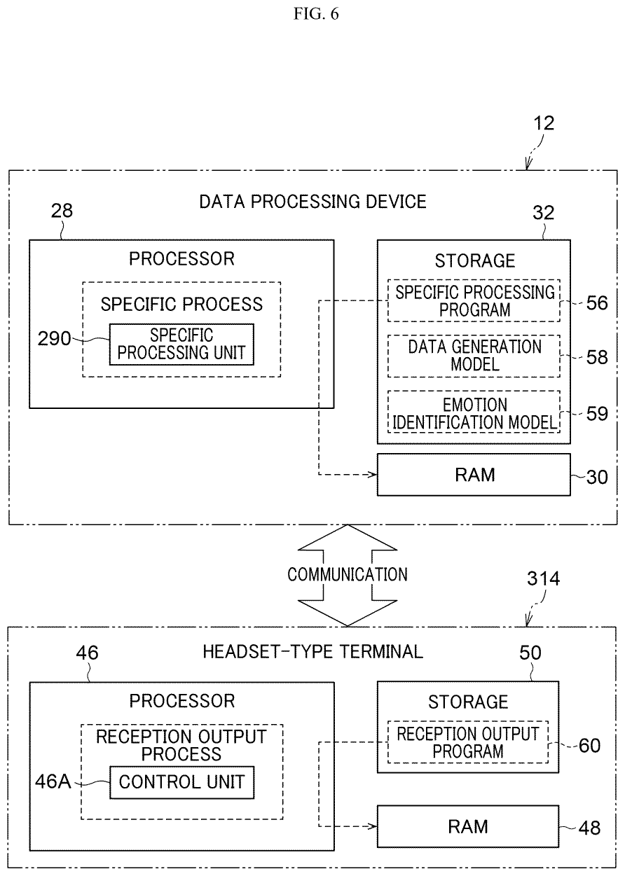

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

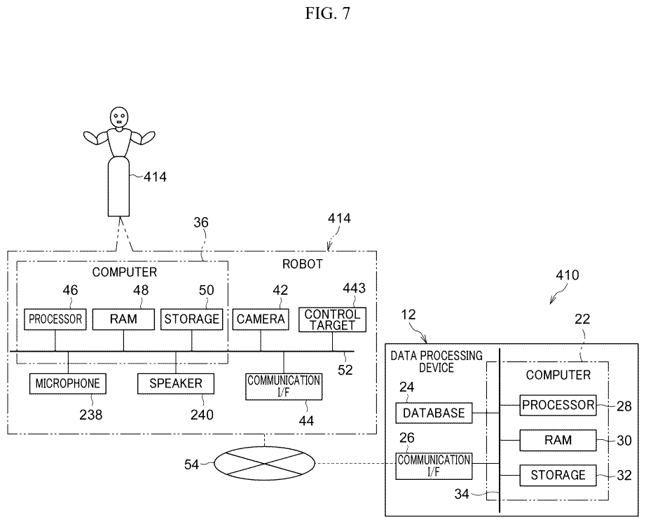

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

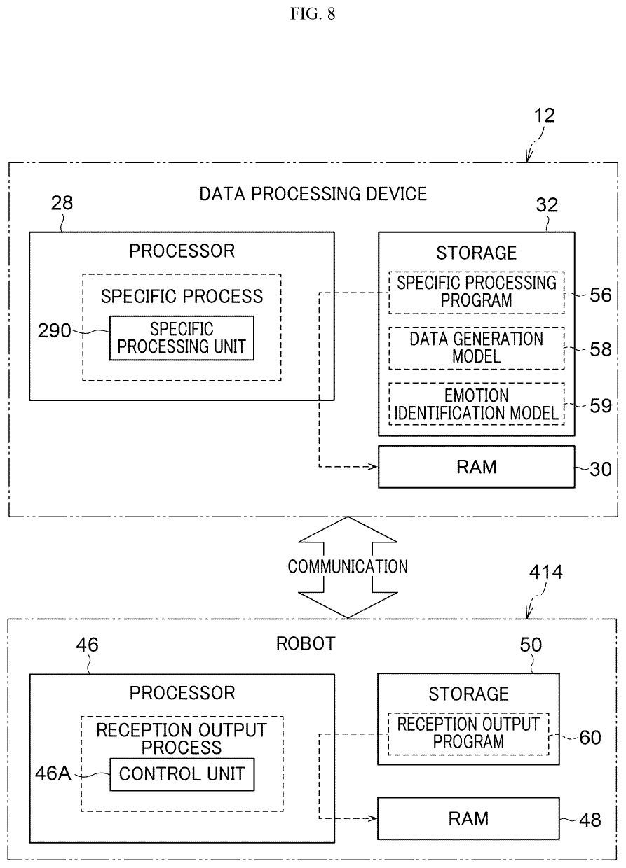

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

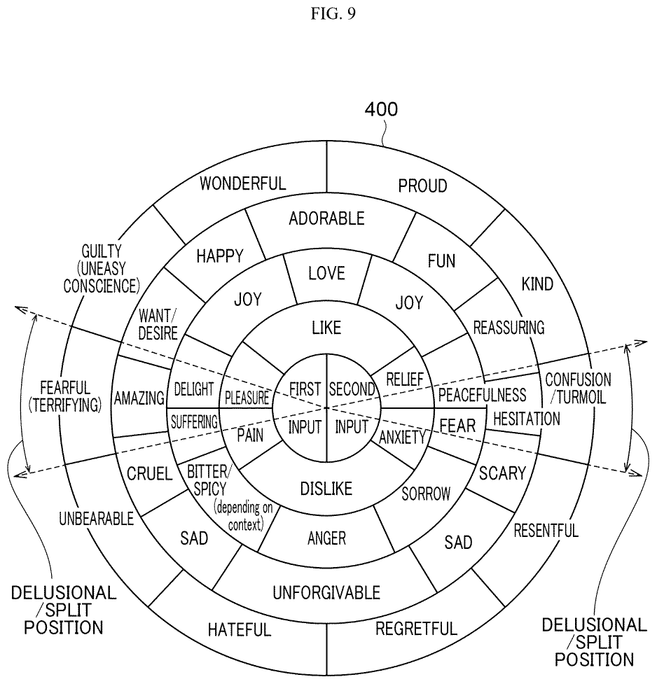

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

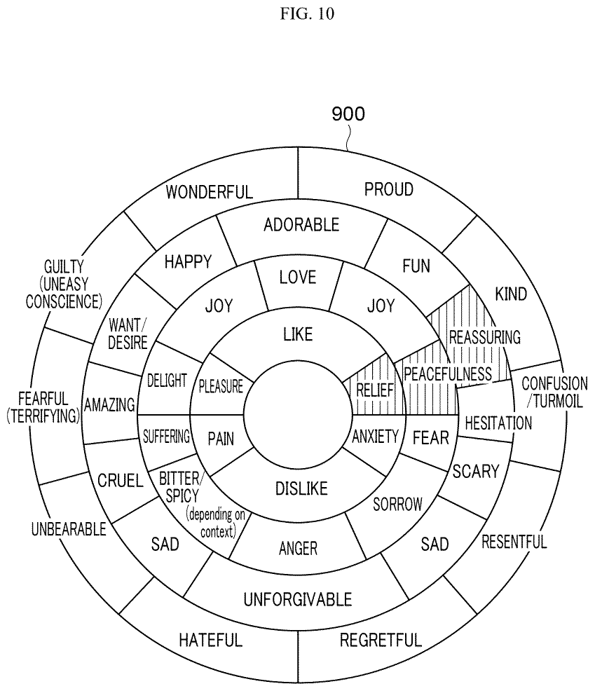

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a communication terminal, information regarding interests, abilities, experiences, and emotions of a user, and convert the information into structured information using an information input unit,
analyze text data included in the structured information using a natural language processing algorithm and an emotion analysis algorithm, and extract user characteristics, user goals, and an emotional state from the structured information using an information analysis unit,
dynamically construct a prompt sentence using a prompt generation unit, the prompt sentence being configured to instruct a generative AI model to generate support content related to personal self-expression, based on the user characteristics, the user goals, and the emotional state extracted by the information analysis unit,
input the prompt sentence constructed by the prompt generation unit into the generative AI model, and cause the generative AI model to perform inference processing so as to generate advice content for self-brand formation in accordance with the user characteristics and the emotional state, using an advice generation unit,
convert the advice content generated by the advice generation unit into a data format, transmit the advice content to the communication terminal using a secure communication protocol, and control the communication terminal so that the advice content is displayed on the communication terminal, using an advice providing unit, and
update the prompt sentence and the advice content in response to additional information or additional input from the user, using an iterative control unit.

### (Supplementary 2)

The system according to supplementary 1,
wherein the processor is configured to cause the information analysis unit to extract, from the text data, feature information representing ability elements as user strengths, preferences, and behavior histories, and to cause the prompt generation unit to embed, into the prompt sentence, profile information in which the feature information is organized by category, thereby instructing the generative AI model to generate a strategy for utilizing the user strengths and an interpersonal communication method.

### (Supplementary 3)

The system according to supplementary 1,
wherein the processor is configured to cause the iterative control unit to re-input additional input received from the communication terminal into the information analysis unit, to cause the prompt generation unit to generate a new prompt sentence reflecting updated user goals or constraint conditions, and to sequentially update the prompt sentence for the generative AI model and the advice content, thereby progressively refining advice related to personal self-expression based on a dialogue history with the user.

### Application Example 1

### (Supplementary 1)

A system comprising a processor,
wherein the processor is configured to
receive, from a terminal, information and dialog information acquired from a user, and perform preprocessing on the information and the dialog information,
construct a prompt sentence based on the preprocessed information and the dialog information, and input the prompt sentence into a generative artificial intelligence model so as to instruct the generative artificial intelligence model to generate support for personal image formation and proposals for goods or services,
obtain proposal content output from the generative artificial intelligence model, compare the proposal content with inventory information or available service information, and generate proposal information to be output to the terminal by formatting the proposal content in accordance with the inventory information or the available service information,
analyze an emotional state of the user or a customer, which is acquired via the terminal, by using an emotion analysis algorithm, and adjust at least one of content and expression style of the prompt sentence or the proposal information in accordance with the emotional state,
cause the terminal to generate digital information representing information on an interest or a demand of the customer by using audio input and image input, to transmit the digital information to a server, and to display, in real time on a display unit, the proposal information received from the server, and
transmit and receive, via a communication network, the digital information and the proposal information between the terminal, the server, and the generative artificial intelligence model.

### (Supplementary 2)

The system according to supplementary 1,
wherein the processor is configured to
construct the prompt sentence by integrating attribute information, interest information, skill information, experience information, past dialog history information of the user or the customer, and the inventory information or the service information, and to generate the prompt sentence that instructs the generative artificial intelligence model to generate a predetermined number of candidate goods or candidate services and, for each of the candidate goods or the candidate services, a description sentence and a conversation guide sentence.

### (Supplementary 3)

The system according to supplementary 1,
wherein the processor is configured to
generate the proposal information by analyzing text information output from the generative artificial intelligence model, converting the text information into structured information for each candidate item, and automatically rewriting tone and expression of the conversation guide sentence in accordance with the emotional state specified by the emotion analysis algorithm and personal image formation policy information of the user, and presenting the proposal information to the terminal in real time.

### Example 2

### (Supplementary 1)

A system comprising a processor and a storage device,
wherein the processor is configured to
receive authentication information and message information transmitted by a user via a communication application operating on a communication terminal, compare the authentication information with user information stored in the storage device to execute an authentication process, transmit an authentication result and screen display data to the communication terminal, store the message information in the storage device, and manage delivery of the message information to a destination user,
generate, based on user-related information including the message information and the user information, a prompt sentence for supporting personal branding of the user, input input data including the prompt sentence into a generative AI model, and acquire, from the generative AI model, personal-branding advice information and message candidate information corresponding to the user-related information,
present the personal-branding advice information and the message candidate information on a message creation screen of the communication terminal in an editable form for the user, obtain final message information as an editing result by the user, store the final message information in the storage device, and perform delivery processing to deliver the final message information as message information to be delivered to the destination user,
determine, based on connection management information, an online state of the destination user, transmit, when the destination user is in an online state, the final message information to the communication terminal of the destination user by a real-time communication method,
store, when the destination user is in an offline state, the final message information in the storage device as undelivered information, and collectively deliver the final message information at a time of next authentication of the destination user, and
store, in the storage device as history information, the prompt sentence input to the generative AI model and the advice information output from the generative AI model in association with user identification information, time information, and conversation identification information, and perform analysis processing based on the history information to improve content or presentation of the prompt sentence.

### (Supplementary 2)

The system according to supplementary 1,
wherein the processor is configured to
acquire, as the user-related information, profile information, skill information, interest information, and past message usage history information of the user from the storage device,
generate context information by integrating the acquired information, and input a prompt sentence including the context information into the generative AI model so as to cause the generative AI model to generate the advice information and the message candidate information in accordance with a personal-branding policy different for each user.

### (Supplementary 3)

The system according to supplementary 1,
wherein the processor is configured to
input the message information created by the user and an expression included in the message information into an emotion analysis algorithm to identify an emotional state, generate a prompt sentence including the identified emotional state and the context information, and input the prompt sentence into the generative AI model so as to cause the generative AI model to generate the message candidate information consistent with the emotional state of the user and the personal-branding policy, and to cause the communication terminal to present the message candidate information.

### Application Example 2

### (Supplementary 1)

A system comprising a processor,
wherein the processor is configured to
acquire and preprocess user information,
dynamically construct a prompt sentence for input to a generative AI model based on the user information and context information including at least one of textual input, sensor input, and location input,
input the prompt sentence into the generative AI model to cause the generative AI model to generate guidance information or content information for supporting formation of a personal brand of a user,
apply an emotion analysis algorithm to at least one of text information, voice information, and image information obtained from a user terminal to identify an emotional state of the user,
adjust at least one of contents of the prompt sentence, the guidance information, and the content information in accordance with the identified emotional state and the user information,
provide the guidance information or the content information to a user terminal for message-based interaction with the user, and
update a construction policy for subsequent prompt sentences based on feedback information received from the user terminal.

### (Supplementary 2)

The system according to supplementary 1,
wherein the processor is configured to
acquire, as the user information, at least attribute information, skill information, interest information, activity history information, and at least one of physical-space position information and item identification information,
generate the prompt sentence for the generative AI model so as to request explanation of brand information relating to a product or service in a real space based on the physical-space position information or the item identification information,
and cause the generative AI model to generate brand story information or background information corresponding to a product or service that the user is focusing on in the real space.

### (Supplementary 3)

The system according to supplementary 1,
wherein the processor is configured to
detect an update of at least one of skill information and experience information of the user, generate, based on the updated skill information or experience information and a change in the emotional state identified from past emotion analysis results, the prompt sentence for the generative AI model to request reconstruction of a personal branding strategy,
cause the generative AI model to generate updated personal branding strategy information, and provide the updated personal branding strategy information to the user terminal.

What is claimed is:

1. A system comprising:
circuitry configured to:
receive, via a communication interface coupled to a packet-switched network, input data from a terminal device, the input data comprising text data associated with a user;
convert the input data into structured information by applying a preprocessing operation to the input data;
analyze the structured information using a natural language processing algorithm and an emotion analysis algorithm to extract feature information comprising user characteristic data, goal data, and an emotional state indicator;
construct a prompt sentence based on the user characteristic data, the goal data, and the emotional state indicator, the prompt sentence being configured to instruct a generative neural network model to generate output content;
input the prompt sentence into the generative neural network model and cause the generative neural network model to execute inference processing to generate the output content in accordance with the user characteristic data and the emotional state indicator;
transmit the output content to the terminal device via the communication interface and the packet-switched network; and
update the prompt sentence and the output content in response to additional input data received from the terminal device by re-analyzing the additional input data, reconstructing the prompt sentence to reflect updated goal data, and refining the output content based on a dialogue history stored in a storage device.

2. The system according to claim 1, wherein the preprocessing operation comprises tokenizing the text data, applying part-of-speech tagging, and mapping tokens to entries in a domain ontology to generate the structured information as a set of categorized feature vectors.

3. The system according to claim 2, wherein the natural language processing algorithm comprises named entity recognition and dependency parsing applied to the tokenized text data, and wherein the user characteristic data comprises at least one of a strength indicator, a preference indicator, or a behavior history indicator extracted from the parsed text data.

4. The system according to claim 3, wherein the circuitry is configured to embed, into the prompt sentence, profile information in which the feature information is organized by category, thereby instructing the generative neural network model to generate strategy data and an interpersonal communication method based on the strength indicator.

5. The system according to claim 1, wherein the emotion analysis algorithm comprises a sentiment classification model that receives the text data as input and outputs an emotion label and a confidence score, and wherein the circuitry is configured to adjust at least one of a tone parameter or a content emphasis parameter in the prompt sentence based on the emotion label.

6. The system according to claim 5, wherein the sentiment classification model comprises a neural network trained on labeled data pairs associating text sequences with emotion categories, and wherein the emotion label is selected from a plurality of affective states mapped in an emotion space defined by at least a valence axis and an arousal axis.

7. The system according to claim 1, wherein the circuitry is configured to construct the prompt sentence by concatenating an explanation segment describing the user characteristic data, a condition segment specifying constraint parameters derived from the goal data, and a format segment defining an output structure for the generative neural network model.

8. The system according to claim 7, wherein the circuitry is configured to select a prompt template from a plurality of prompt templates stored in the storage device based on a classification of the goal data, and to perform variable substitution to insert the user characteristic data and the emotional state indicator into placeholder positions within the selected prompt template.

9. The system according to claim 1, wherein the circuitry is configured to update the prompt sentence by re-inputting the additional input data into the natural language processing algorithm and the emotion analysis algorithm, generating updated feature information, and reconstructing the prompt sentence using the updated feature information and the dialogue history, thereby progressively refining the output content across successive interaction turns.

10. The system according to claim 9, wherein the circuitry is configured to maintain the dialogue history as a sequence of interaction records in the storage device, each interaction record comprising an input text segment, a corresponding prompt sentence, and the output content generated by the generative neural network model, and to compute a context vector from the dialogue history for inclusion in a subsequently constructed prompt sentence.

11. The system according to claim 1, wherein the circuitry is configured to compare the output content with reference data stored in a data store, generate proposal information by associating the output content with matching entries in the data store, and transmit the proposal information to the terminal device.

12. The system according to claim 11, wherein the circuitry is configured to filter the matching entries based on availability data stored in the data store, and to format the proposal information in accordance with a display template for rendering on the terminal device.

13. The system according to claim 11, wherein the circuitry is configured to adjust a ranking of the matching entries based on the emotional state indicator, such that entries associated with attributes corresponding to the emotional state indicator are ranked higher in the proposal information.

14. The system according to claim 1, wherein the circuitry is configured to generate the output content as self-expression support data comprising at least one of a strategy for emphasizing user strengths, a communication style recommendation, or a profile description adapted to the emotional state indicator.

15. The system according to claim 14, wherein the self-expression support data comprises personal branding advice including at least one of a suggested self-introduction, a recommended skill emphasis, or a contextual messaging strategy based on the user characteristic data and the goal data.

16. The system according to claim 1, wherein the generative neural network model comprises a transformer architecture including a plurality of self-attention layers and feed-forward layers, and wherein the circuitry is configured to control a temperature parameter and a sampling strategy during inference processing based on the emotional state indicator.

17. The system according to claim 1, wherein the circuitry is configured to estimate the emotional state indicator by applying the emotion analysis algorithm to at least one of the text data or sensor data received from the terminal device, the sensor data comprising at least one of voice data, facial image data, or biometric data.

18. A system comprising:
circuitry configured to:
receive, via a communication interface coupled to a packet-switched network, text data and context data from a terminal device;
apply a natural language processing pipeline comprising tokenization, entity extraction, and dependency parsing to the text data to generate structured feature data comprising a user characteristic vector and a goal indicator;
apply an emotion analysis model to at least one of the text data or sensor data received from the terminal device to generate an emotional state label and a confidence score;
construct a prompt sentence by selecting a prompt template from a storage device based on the goal indicator, and embedding the user characteristic vector, the goal indicator, and the emotional state label into the prompt template;
input the prompt sentence into a generative neural network model comprising a transformer architecture with self-attention layers, and obtain output content generated by the generative neural network model;
transmit the output content to the terminal device via the communication interface and the packet-switched network;
store an interaction record comprising the text data, the prompt sentence, and the output content in the storage device as dialogue history; and
upon receiving additional input data from the terminal device, re-analyze the additional input data using the natural language processing pipeline and the emotion analysis model, reconstruct the prompt sentence using updated feature data and the dialogue history, and generate updated output content.

19. The system according to claim 18, wherein the circuitry is configured to compare the output content with reference entries stored in a data store, associate matching entries with the output content based on attribute similarity, and generate proposal data comprising the matching entries with availability information and display formatting for transmission to the terminal device.

20. A method comprising:
receiving, via a communication interface coupled to a packet-switched network, input data from a terminal device, the input data comprising text data associated with a user;
converting the input data into structured information by applying a preprocessing operation to the input data;
analyzing the structured information using a natural language processing algorithm and an emotion analysis algorithm to extract feature information comprising user characteristic data, goal data, and an emotional state indicator;
constructing a prompt sentence based on the user characteristic data, the goal data, and the emotional state indicator, the prompt sentence being configured to instruct a generative neural network model to generate output content;
inputting the prompt sentence into the generative neural network model and causing the generative neural network model to execute inference processing to generate the output content in accordance with the user characteristic data and the emotional state indicator;
transmitting the output content to the terminal device via the communication interface and the packet-switched network; and
updating the prompt sentence and the output content in response to additional input data received from the terminal device by re-analyzing the additional input data, reconstructing the prompt sentence to reflect updated goal data, and refining the output content based on a dialogue history stored in a storage device.
